(19) United States
(12) Patent Application Publication
(10) Pub. No.: US 2026/0090531 A1
(43) Pub. Date: Apr. 2, 2026

(54) FISHING REEL ELECTROMAGNETIC BRAKING DEVICE, FISHING LINE AND SPEED MEASUREMENT MECHANISM

(71) Applicant: Zhaozhou SHI, Shanghai (CN)

(72) Inventor: Zhaozhou SHI, Shanghai (CN)

(21) Appl. No.: 18/992,193

(22) PCT Filed: Jun. 28, 2023
(86) PCT No.: PCT/CN2023/103454

§ 371 Date: Dec. 3, 2025

(30) Foreign Application Priority Data
Jul. 10, 2022 (CN) 202210806287.1
Jul. 27, 2022 (CN) 202210893706.X
Feb. 16, 2023 (CN) 202310119377.8
Mar. 6, 2023 (CN) 202310206146.0

(51) Int. Cl. A01K 89/0155; G01P 3/38

(52) U.S. Cl. CPC A01K 89/01555; G01P 3/38

(57) ABSTRACT

A fishing reel for fishing, a fishing line and a speed measurement mechanism. The fishing reel comprises a fishing reel electromagnetic braking device for winding and releasing a fishing line by rotating a winding reel. The fishing reel electromagnetic braking device comprises: a braking mechanism provided with a braking coil and a magnetic braking member, a guide ring speed measurement mechanism, a rotation detection mechanism, and a controller. A line output speed of the fishing reel and a tangential speed of the winding reel rotating to release the fishing line are measured in real time, and are compared to control a braking force of the winding reel according to the difference therebetween, so as to achieve closed-loop control, thereby improving the stability of the braking effect. The fishing reel electromagnetic braking device can automatically correct the braking force, automatically set and store parameters, and reduce the complexity of parameter setting.

### CROSS-REFERENCE TO RELATED APPLICATION

The present application claims the benefit of priority to Chinese Patent Application No. 202210806287.1, entitled “FISHING REEL ELECTROMAGNETIC BRAKING DEVICE AND FISHING LINE”, filed with CNIPA on Jul. 10, 2022, the disclosure of which is incorporated herein by reference in its entirety for all purposes;

The present application claims the benefit of priority to Chinese Patent Application No. 202210893706.X, entitled “FISH REEL ELECTROMAGNETIC BRAKING DEVICE AND FISHING LINE”, filed with CNIPA on Jul. 27, 2022, the disclosure of which is incorporated herein by reference in its entirety for all purposes;

The present application claims the benefit of priority to Chinese Patent Application No. 202310119377.8, entitled “FISHING REEL ELECTROMAGNETIC BRAKING DEVICE, FISHING LINE AND SPEED MEASUREMENT MECHANISM”, filed with CNIPA on Feb. 16, 2023, the disclosure of which is incorporated herein by reference in its entirety for all purposes;

The present application claims the benefit of priority to Chinese Patent Application No. 202310206146.0, entitled “LINE SPEED MEASUREMENT DEVICE”, filed with CNIPA on Mar. 6, 2023, the disclosure of which is incorporated herein by reference in its entirety for all purposes.

### FIELD OF THE INVENTION

The present application relates to fishing equipment, and in particular to a fishing reel electromagnetic braking device, a fishing line and a speed measurement mechanism.

### BACKGROUND OF THE INVENTION

During the process of casting bait with a fishing reel, the fishing line is pulled out of the line outlet of the fishing reel due to inertia, driving the winding reel to rotate and release the line. The flying speed of the bait is attenuated by air resistance and friction of the fishing line. When the speed at which the winding reel releases the fishing line due to inertia is greater than the speed at which the fishing line is pulled out of the line outlet of the fishing reel, part of the fishing line is retained inside the fishing reel to form a floating line, which in turn causes a tangled fishing line. Therefore, the fishing reel is provided with a device for braking and decelerating the winding reel to prevent the fishing line from getting tangled when casting the bait. In the fishing reel electromagnetic braking device disclosed in Chinese Patent Authorization Publication No. CN1965645B and Chinese Patent Authorization Publication No. CN110432236A, when the winding reel rotates to release the line, the magnetic rotor (or the rotor coil) rotating integrally with the winding reel and the stator coil (or the magnetic stator) arranged on the fishing reel body rotate relative to each other. The induced current in the stator coil (or the rotor coil) is controlled by preset parameters and programs, such that the winding reel is braked and decelerated.

### SUMMARY OF THE INVENTION

Due to the frequent changes in wind force, bait, fishing line, and other factors in an actual fishing scenario, the attenuation law of the outlet speed of the fishing line pulled out of the fishing reel during a bait casting process is uncertain due to the interference of complex factors. The conventional technology does not detect the outlet speed, nor can it dynamically monitor the matching condition between the outlet speed and the speed at which the winding reel rotates to release the fishing line. It only performs open-loop control on the braking force of the winding reel according to preset programs and parameters, and is unable to dynamically correct the speed of the winding reel that deviates from an appropriate value, resulting in unstable braking effect. When the braking force is insufficient, excessive rotational speed of the winding reel causes the fishing line to be tangled, while excessive braking force consumes additional kinetic energy of the bait and shortens the flight distance of the bait. In addition, the conventional fishing reel electromagnetic braking device requires complex parameter settings in advance.

According to the embodiments of the present application, a fishing reel electromagnetic braking device, a fishing line, and a speed measurement mechanism are provided.

The embodiments of a first aspect of the present application provide a fishing reel electromagnetic braking device. A fishing wheel equipped with the fishing reel electromagnetic braking device includes an outlet guide ring and a winding reel for reeling and releasing a fishing line in a rotation method. The fishing reel electromagnetic braking device includes a braking mechanism. The braking mechanism includes a braking coil and a magnetic braking member. The braking coil is disposed to face the magnetic braking member. One of the magnetic braking member and the braking coil rotates integrally with the winding reel to form a rotor, and the other of the magnetic braking member and the braking coil is disposed on a fishing reel body to form a stator. When a line is released, the magnetic braking member and the braking coil rotate relative to each other, and interact with each other to generate electromagnetic induction to brake the winding reel. The fishing reel electromagnetic braking device further includes a guide ring speed measurement mechanism, a rotation detection mechanism and a controller.

The guide ring speed measurement mechanism is a linear speed sensor disposed on an inner wall of the outlet guide ring and is configured to detect speed information of the fishing line passing through the outlet guide ring.

The rotation detection mechanism is disposed on the fishing reel body. The rotation detection mechanism includes a main rotation speed sensor and a rotation direction detection device and is configured to detect rotation information of the winding reel. The rotation information includes information of a rotation pulse and a rotation direction.

The controller is disposed on the fishing reel body and includes a processor, a memory, a current control unit, and an I/O interface. The controller is electrically connected with the guide ring speed measurement mechanism and the rotation detection mechanism through the I/O interface. The current control unit is electrically connected with the braking coil. The memory records and stores a conversion relationship parameter between a count of winding turns, a rotation speed, and a tangential speed of the winding reel.

When the line is released, the controller controls a braking force of the winding reel to realize closed-loop control in the following method: calculating a fishing line speed through the outlet guide ring according to the speed information; calculating the rotation direction, the rotation speed, and the count of winding turns of the winding reel according to the rotation information, and storing the count of winding turns in the memory; when the rotation direction of the winding reel is to release the line, calculating the tangential speed according to the count of winding turns, the rotation speed, and the conversion relationship parameter of the winding reel, calculating a correction signal for correcting the rotation speed of the winding reel according to the fishing line speed simultaneous with the tangential speed, and controlling an electromagnetic induction current in the braking coil through the current control unit according to the correction signal.

Optionally, in the embodiments of the first aspect, the guide ring speed measurement mechanism detects the speed information and sends the speed information to the controller for processing, which is implemented in any of the following manners:

The guide ring speed measurement mechanism further includes a projection light source and a photoelectric sensor. A fishing line used is spaced by color segments of different reflectivities with a first fixed marker length. The projection light source illuminates the fishing line, and the photoelectric sensor converts a detected reflected light signal into an electrical pulse signal. The electrical pulse signal and the first fixed marker length are used to calculate the fishing line speed through the outlet guide ring. Or the guide ring speed measurement mechanism further includes a projection light source and an image sensor. The projection light source illuminates the fishing line, and the image sensor picks up local image information of the moving fishing line at a fixed time interval. The controller performs a front-to-back comparison analysis on the local images, and the fishing line speed through the outlet guide ring is calculated based on a distance moved by the local images at the fixed time interval. Or the guide ring speed measurement mechanism is a magneto-sensitive sensor, and the fishing line used in the guide ring speed measurement mechanism is spaced with magnetic markers with a second fixed marker length. The magneto-sensitive sensor converts a detected magnetic signal into an electrical pulse signal, and the fishing line speed through the outlet guide ring is calculated based on the electrical pulse signal and the second fixed marker length.

Optionally, in the embodiments of the first aspect, the controller controls the electromagnetic induction current in the braking coil in any of the following methods:

The current control unit is a switching element, and the correction signal controls connection and disconnection of the switching element by switching on and off; or, the current control unit is a switching element, and the correction signal controls a duration proportion of connection and disconnection of the switching element by adjusting a PWM signal duty cycle; or, the current control unit is a current intensity adjustment element, and the correction signal adjusts a current intensity in the current intensity adjustment element by changing an intensity.

Optionally, in the embodiments of the first aspect, the closed-loop control is implemented in any of the following methods:

The fishing line speed through the outlet guide ring is used as an input target control quantity, and the tangential speed is used as an output controlled quantity and a feedback quantity; or, a set allowable speed difference threshold is used as an input target control quantity, and a difference between the tangential speed and the fishing line speed through the outlet guide ring is used as an output controlled quantity and a feedback quantity; or, a set allowable floating line length threshold is used as an input target control quantity, and a floating line length is used as an output controlled quantity and a feedback quantity; or, a set integral difference control value is used as an input target control quantity, and a speed integral difference is used as an output controlled quantity and a feedback quantity.

Optionally, in the embodiments of the first aspect, the main rotation speed sensor is a photoelectric sensor, a Hall sensor, an aberration speed sensor, an electromagnetic sensor, or an inductive sensor.

The embodiments of a second aspect of the present application provide a fishing line having signal marker intervals with a fixed marker length. A guide ring speed measurement mechanism of a fishing reel can detect the signal makers and can convert information of the signal makers into an electric pulse signal. A fishing line speed through the outlet guide ring is calculated based on the electric pulse signal and the fixed marker length. The signal marker intervals are formed by color segments arranged at intervals with different reflectivity. The guide ring speed measurement mechanism includes a projection light source and a photoelectric sensor.

The embodiments of a third aspect of the present application provide a fishing line having signal marker intervals with a fixed marker length. A guide ring speed measurement mechanism of a fishing reel can detect signal makers and can convert information of the signal makers into an electric pulse signal. A fishing line speed through the outlet guide ring is calculated based on the electric pulse signal and the fixed marker length. A magnetic material is attached to the fishing line. The signal marker intervals are formed by recording a series of magnetic signals. The guide ring speed measurement mechanism includes a magneto-sensitive sensor.

The embodiments of a fourth aspect of the present application provide a speed measurement mechanism. The speed measurement mechanism is a linear speed sensor disposed on an inner wall of an outlet guide ring and is configured to detect speed information of a fishing line passing through the outlet guide ring. The speed measurement mechanism is implemented in any one of the following methods.

The speed measurement mechanism further includes a projection light source and a photoelectric sensor. The fishing line used is spaced with color segments of different reflectivities with a first fixed marker length. The projection light source illuminates the fishing line, and the photoelectric sensor converts a detected reflected light signal into an electric pulse signal. A fishing line speed through the outlet guide ring is measured based on the electric pulse signal and the first fixed marker length; or, the speed measurement mechanism further includes a projection light source and an image sensor. The projection light source illuminates the fishing line. The image sensor picks up local images of the moving fishing line at a fixed time interval. The controller performs a front-to-back comparison analysis on the local images, and a fishing line speed through the outlet guide ring is calculated based on a distance moved by the local images at the fixed time interval; or, the speed measurement mechanism is a magneto-sensitive sensor, the fishing line used is spaced by magnetic markers with a second fixed marker length, the magneto-sensitive sensor converts a detected magnetic signal into an electrical pulse signal, and a fishing line speed through the outlet guide ring is calculated based on the electrical pulse signal and the second fixed marker length.

Optionally, in the embodiments of the fourth aspect: when the speed measurement mechanism includes the photoelectric sensor or the image sensor, the speed measurement mechanism further includes a light escape notch disposed on an inner wall of an outlet guide ring. A detection direction of the linear speed sensor exactly faces the light escape notch. When the speed measurement mechanism is implemented by the magneto-sensitive sensor, the magneto-sensitive sensor is a magnetic head protruding from the inner wall of the outlet guide ring. The speed measurement mechanism is further provided with a positioning support disposed on the inner wall of the outlet guide ring. The positioning support maintains a clearance between the fishing line in the outlet guide ring and the magnetic head at 0 or at a stable operation.

The embodiments of a fifth aspect of the present application provide a line speed measurement device. The line speed measurement device includes a linear speed sensor. Guide rings are respectively provided on both sides of a detection window of the linear speed sensor. The linear speed sensor and the guide rings are fixedly assembled on a connection device. A measured line passes through the guide rings. The guide rings guide the measured line to maintain a measurable distance between the measured line and the linear speed sensor. The line speed measurement device is configured to measure a reeling and releasing speed of a fishing line for the fishing reel. The measured line is the fishing line. The linear speed sensor is a reflective speed sensor or an aberration speed sensor.

Optionally, in the embodiments of the fifth aspect: the connection device is a housing of the linear speed sensor, and he linear speed sensor and the guide rings are fixedly connected as a whole through the housing; or, the connection device is at least one of a fishing rod and the fishing reel, and the linear speed sensor and the guide rings maintain a relatively fixed position relationship in a speed measurement operation state.

The embodiments of a sixth aspect of the present application provide a fishing reel electromagnetic braking device. The fishing reel electromagnetic braking device applied to a fishing reel with an outlet guide ring and a winding reel. The fishing reel electromagnetic braking device includes a braking coil and a magnetic braking member that rotates integrally with the winding reel. The braking coil is fixedly disposed on a fishing reel body. When a line is released, the braking coil brakes the winding reel through electromagnetic induction. The fishing reel electromagnetic braking device further includes a guide ring speed measurement mechanism, a rotation detection mechanism and a controller.

The guide ring speed measurement mechanism is a linear speed sensor disposed at a line outlet of the fishing reel and is configured to detect speed information of a fishing line passing through the outlet guide ring. The fishing line is provided with signal marker sequences arranged at intervals, and the signal marker sequences match geometric parameters of the winding reel, such that an interval length of the signal marker sequences increases or decreases in proportion to an increase or a decrease of a winding diameter of the fishing line on the winding reel, and a ratio of the interval length of the signal marker sequences to the corresponding winding diameter meets a preset value.

The rotation detection mechanism is disposed on the fishing reel body and includes a rotation speed sensor configured to detect rotation speed information of the winding reel.

The controller is disposed on the fishing reel body and includes a processor, a memory, and a current control unit. The controller is electrically connected with the guide ring speed measurement mechanism and the rotation detection mechanism. The current control unit is electrically connected with the braking coil, and the memory stores the preset value.

When the line is released, the controller performs the closed-loop control in the following method: the controller calculates a count of signal markers of the fishing line passing through the line outlet and a rotation angle of the winding reel within the same time period. A fishing line speed through the outlet guide ring and a tangential speed are calculated according to the count of signal markers, the rotation angle of the winding reel, and the preset value to calculate a correction signal for correcting a rotation speed of the winding reel. Electromagnetic induction current in the braking coil is controlled through the current control unit according to the correction signal.

Optionally, in the embodiments of the sixth aspect, the linear speed sensor is disposed on an inner wall or a side of the outlet guide ring of the fishing reel, and a detection direction of the linear speed sensor points to the fishing line passing through the line outlet. The guide ring speed measurement mechanism detects speed information and send the speed information to the controller for processing, which is implemented in any of the following methods: the guide ring speed measurement mechanism further includes a projection light source and a photoelectric sensor, the signal marker sequences are formed by color segments with different reflectivities arranged at intervals, the projection light source illuminates the fishing line, and the photoelectric sensor converts a detected reflected light signal into an electrical pulse signal; or the guide ring speed measurement mechanism is a magneto-sensitive sensor, the signal marker sequences are formed by magnetic markers arranged at intervals, and the magneto-sensitive sensor converts a detected magnetic signal into an electrical pulse signal.

Optionally, in the embodiments of the sixth aspect, the controller controls the electromagnetic induction current in the braking coil in any of the following methods: the current control unit is a switching element, and the correction signal controls connection and disconnection of the switching element by switching on and off; or, the current control unit is a switching element, and the correction signal controls a duration proportion of connection and disconnection of the switching element by adjusting a PWM signal duty cycle; or, the current control unit is a current intensity adjustment element, and the correction signal adjusts a current intensity in the current intensity adjustment element by changing an intensity.

Optionally, in the embodiments of the sixth aspect, the closed-loop control is implemented in any one of the following methods: the fishing line speed through the outlet guide ring is used as an input target control quantity, and the tangential speed is used as an output controlled quantity and a feedback quantity; or, a set allowable speed difference threshold is used as an input target control quantity, and a difference between the tangential speed and the fishing line speed through the outlet guide ring is used as an output controlled quantity and a feedback quantity; or, a set allowable floating line length threshold is used as an input target control quantity, and a floating line length is used as an output controlled quantity and a feedback quantity; or, a set integral difference control value is used as an input target control quantity, and a speed integral difference is used as an output controlled quantity and a feedback quantity.

Optionally, in the embodiments of the sixth aspect, the rotation speed sensor is a photoelectric sensor, a Hall sensor, an aberration speed sensor, an electromagnetic sensor, or an inductive sensor.

The embodiments of a seventh aspect of the present application provide a fishing line. The fishing line is matched with the fishing reel electromagnetic braking device described in any one of the embodiments of the sixth aspect.

The embodiments of an eighth aspect of the present application provide a fishing reel electromagnetic braking device, applied to a fishing reel having an outlet guide ring and a winding reel. The fishing reel electromagnetic braking device includes a braking coil and a magnetic braking member rotating integrally with the winding reel. The braking coil is fixedly disposed on a fishing reel body, and the braking coil brakes the winding reel through electromagnetic induction when a line is released. The fishing reel electromagnetic braking device further includes a guide ring speed measurement mechanism, a reel aberration speed measurement device and a controller.

The guide ring speed measurement mechanism is a linear speed sensor disposed at a line outlet of the fishing reel and configured to detect a fishing line speed through the outlet guide ring.

The reel aberration speed measurement device is disposed on the fishing reel body and a detection direction of the reel aberration speed measurement device points to a fishing line on a surface of the winding reel. the reel aberration speed measurement device is configured to detect a tangential speed of the fishing line on the surface of the winding reel.

The controller is disposed on the fishing reel body and includes a processor, a memory and a current control unit. The controller is electrically connected with the guide ring speed measurement mechanism, and the current control unit is electrically connected with the braking coil.

When the line is released, the controller performs the closed-loop control. The controller calculates a correction signal for correcting the rotation speed of the winding reel based on the fishing line speed through the outlet guide ring and the tangential speed, and controls electromagnetic induction current in the braking coil through the current control unit based on the correction signal.

Optionally, in the embodiments of the eighth aspect, the linear speed sensor is disposed on an inner wall or a side of the outlet guide ring of the fishing reel, such that the detection direction points to the fishing line output by the outlet guide ring. The guide ring speed measurement mechanism detects speed information and send the speed information to the controller for processing, which is implemented in any of the following methods: the guide ring speed measurement mechanism further includes a projection light source and a photoelectric sensor, and the fishing line used is spaced by color segments of different reflectivities with a first fixed marker length, the projection light source illuminates the fishing line, the photoelectric sensor converts a detected reflected light signal into an electrical pulse signal, and the fishing line speed through the outlet guide ring is calculated based on the electrical pulse signal and the first fixed marker length; or, the guide ring speed measurement mechanism further includes a projection light source and an image sensor, the projection light source illuminates the fishing line, the image sensor picks up local images of the moving fishing line at a fixed time interval, the controller performs a front-to-back comparison analysis on the local images, and the fishing line speed through the outlet guide ring is calculated based on a distance moved by the local images at the fixed time interval; or, the guide ring speed measurement mechanism is a magneto-sensitive sensor, the fishing line used is spaced by magnetic markers with a second fixed marker length, the magneto-sensitive sensor converts a detected magnetic signal into an electrical pulse signal, and the fishing line speed through the outlet guide ring is calculated based on the electrical pulse signal and the second fixed marker length.

Compared with the conventional technology, the beneficial effects of the present application are as follows: the fishing line and the speed measurement mechanism of the present application can detect the outlet speed of the fishing reel; the fishing reel electromagnetic braking device of the present application can control the braking force according to the matching condition between the outlet speed and the tangential speed of the winding reel rotating to release the fishing line, and correct the rotation speed deviation of the winding reel in time to realize closed-loop control, thereby improving the braking stability of the fishing reel. In addition, the embodiments of the present application can also reduce the complexity of parameter setting. The details of one or more embodiments of the present application are set forth in the accompanying drawings and the description below. Other features, objectives, and advantages of the application will become apparent from the description, drawings, and the claims.

### BRIEF DESCRIPTION OF DRAWINGS

FIG. 1 is a perspective view of an appearance of a fishing reel of the prior art.

FIG. 2 is a perspective exploded view of a fishing reel braking mechanism of the prior art.

FIG. 3 is a schematic diagram of a system composition of a fishing reel electromagnetic braking device according to an embodiment of the present application.

FIG. 4 is a schematic cross-sectional view of a guide ring speed measurement mechanism according to an embodiment of the present application.

FIG. 5 is a schematic diagram of a detailed structure of a guide ring speed measurement mechanism according to an embodiment of the present application.

FIG. 6 is a schematic cross-sectional view of a guide ring speed measurement mechanism according to an embodiment of the present application.

FIG. 7 is a schematic diagram of a winding reel left side plate and speed reflective markers according to an embodiment of the present application.

FIG. 8 is a flowchart of processing steps of a controller according to an embodiment of the present application.

FIG. 9 is a flowchart of processing steps of a controller according to some embodiments of the present application.

FIG. 10 is a block diagram of a first closed-loop control method according to an embodiment of the present application.

FIG. 11 is a block diagram of a second closed-loop control method according to an embodiment of the present application.

FIG. 12 is a block diagram of a third closed-loop control method according to an embodiment of the present application.

FIG. 13 is a schematic diagram of a recording table for a conversion relationship according to an embodiment of the present application.

FIG. 14 is a schematic diagram of a first fishing line.

FIG. 15 is a schematic diagram of a second fishing line.

FIG. 16 is a schematic cross-sectional view of a light escape notch of a guide ring speed measurement mechanism according to an embodiment of the present application.

FIG. 17 is a schematic cross-sectional view of a light escape notch at an end portion of a guide ring speed measurement mechanism according to an embodiment of the present application.

FIG. 18 is a schematic cross-sectional view of a positioning support of a guide ring speed measurement mechanism according to an embodiment of the present application.

FIG. 19 is a schematic cross-sectional view of a line speed measurement device according to an embodiment of the present application.

FIG. 20 is a schematic composition diagram of a line speed measurement device according to an embodiment of the present application.

### REFERENCE NUMERALS

100 fishing reel body
200 winding reel
300 clutch switch
400 outlet guide ring
500 reeling handle
600 guide ring speed measurement mechanism
700 rotation detection mechanism
800 braking mechanism
900 controller
201 winding reel left side plate
202 winding reel shaft
401 light escape notch
410 positioning support
450 guide ring
601 projection light source
602 light receiving part
603 first lens
604 second lens
605 third lens
606 beam splitter
701 speed reflective markers
801 braking coil
802 magnetic braking member
803 connection part
901 processor
902 I/O interface
903 current control unit
904 RAM memory
905 ROM memory
906 flash memory (FLASHROM)
911 closed-loop control calculation module
912 fishing line speed calculation module
913 tangential speed calculation module
ΔV calculation module
915 L_{f} calculation module
1000 fishing line

### DETAILED DESCRIPTION

The following further describes the embodiments of the present application. These descriptions are all exemplary and are intended to enable those skilled in the art to implement the embodiments of the present application, but are not intended to limit the scope of protection of the present application. It should be noted that the embodiments of the present application and the features therein may be combined with each other without conflict.

This specification also does not describe the content that is indispensable for actual implementation but irrelevant to understanding the present application, such as power supply, compilation instructions, specific working process of the processor, specific algorithm of closed-loop control, etc. These contents are all known technologies, and those skilled in the art should be aware that these known technologies can be applied to the embodiments of the present application in various ways based on this specification.

In the drawings, the identical or similar reference numerals throughout represent the same or similar components, or components with the same or similar functions.

In the description of this specification, phrases such as “one embodiment” or “some embodiments” mean that one or more embodiments of this specification include specific features, structures or characteristics described in conjunction with the embodiment. “One embodiment,” “in some embodiments,” “in other embodiments,” and the like appearing in different places in this specification do not necessarily all refer to the same embodiment, but rather mean “one or more but not all embodiments,” unless specifically emphasized otherwise.

In addition, in the description of the embodiments of this specification, “plurality” refers to two or more than two, and the terms “include”, “comprise”, “have”, and their variations all mean “include but are not limited to”, unless otherwise specifically emphasized.

The “outlet guide ring” or “guide ring” involved in the present application specifically refers to the line outlet component of the fishing reel, through which the output fishing line passes and is led out to the outside of the fishing reel. For example, the “line lead gauge” or “line gauge” of a double-bearing fishing reel usually belongs to this type of component.

The fishing line speed V through the outlet guide ring involved in the present application specifically refers to a speed at which a fishing line passes through an outlet guide ring 400 when the fishing line is reeled in or released, or is equivalently understood as a length of the fishing line passing through the outlet guide ring 400 in a certain inspection time period T. The tangential speed Vₜ involved in the present application specifically refers to a speed at which the fishing line is wound or released when a winding reel 200 rotates, or is equivalently understood as a length of the fishing line wound or released due to the rotation of the winding reel 200 in the certain inspection time period T. The rotation speed Vᵣ involved in the present application specifically refers to a rotation speed of the winding reel 200, or is equivalently understood as a count of rotations of the winding reel 200 in the certain inspection time period T. The above inspection time period T may be a fixed absolute time during, such as 1 s, or may be a relative reference time period, such as taking a time period when the winding reel 200 rotates a certain angle A as the inspection time period T.

In some embodiments, the speed at which the fishing line passes through the line outlet and the speed at which the fishing line is released from the winding reel are each divided by a certain metric transformation value to obtain a “relative fishing line speed through the outlet guide ring” and a “relative tangential speed”, respectively. In this case, the “fishing line speed V through the outlet guide ring” may also be the relative fishing line speed through the outlet guide ring, and the “tangential speed Vₜ” may also be the relative tangential speed, which will be described in detail with examples in Embodiment 2.

The “count of winding turns” or the “count of winding turns of the winding reel” involved in the present application specifically refers to the count of winding turns of the fishing line on the winding reel. The “line being released” involved in the present application specifically refers to the operation state of the winding reel releasing the fishing line. The “winding diameter” or “winding body diameter” involved in the present application specifically refers to the overall diameter after the fishing line is wound on the winding reel.

The controller involved in the present application refers to a circuit device having a circuit substrate and electronic components and stored software. The current control unit involved in the present application specifically refers to an element or a combination of elements that controls the on/off switching of current or the change of current intensity by an input signal. The electrical connection involved in the present application specifically refers to a circuit connection or a connection mode for transmitting electrical signal or electrical energy through a wireless connection.

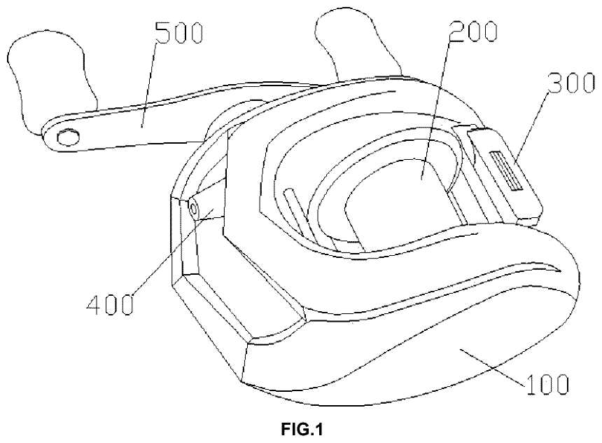

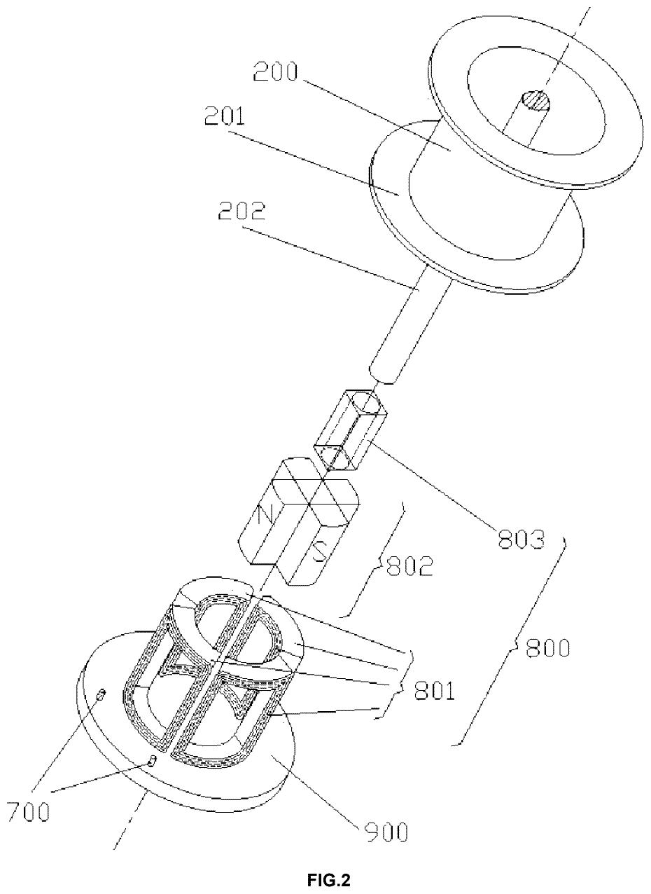

FIG. 1 and FIG. 2 illustrate a fishing reel in the prior art. The fishing reel includes: a fishing reel body 100, a winding reel 200, a clutch switch 300, an outlet guide ring 400, and a reeling handle 500. A gear transmission mechanism and a clutch mechanism are provided in the fishing reel. When a fishing line is reeled, the clutch mechanism is engaged, and the reeling handle 500 drives the winding reel 200 to rotate through the gear transmission mechanism. When the clutch switch 300 is pressed, the clutch mechanism is disengaged, the winding reel 200 is separated from the transmission mechanism, and at this time the winding reel 200 can rotate freely and is in a line releasing state. Left and right side plates are provided on two sides of the winding reel 200, respectively, and the winding reel 200 and a winding reel shaft 202 are fixed as an integrated structure and operate in linkage with each other (see FIG. 2). Left and right side covers are provided on two sides of the fishing reel body 100, respectively. The above are some common structural forms of the fishing reel in the prior art. Fishing reels with such structures are also commonly referred to as double-bearing fishing reels.

The present application relates to a braking mechanism of a fishing reel electromagnetic braking device. It is a known technology to brake a rotation mechanism using electromagnetic induction. Specific applications such as a related winding reel braking component disclosed in Chinese Patent Application CN110432236A and CN1806540A, including a plurality of magnets and a plurality of coils. As another example, a brake energy recovery system is applied to some vehicles. In order to facilitate understanding of the embodiments of the present application, a commonly known braking mechanism is described first.

As shown in FIG. 2, a braking mechanism 800 includes a braking coil 801 and a magnetic braking member 802. The braking mechanism 800 brakes the winding reel 200 through electromagnetic induction during the process of releasing the fishing line. The magnetic braking member 802 is a magnetic rotor that rotates integrally with the winding reel 200. The braking coil 801 is a stator coil disposed on the fishing reel body 100. The braking coil 801 is disposed to face the magnetic braking member 802, such that the braking coil 801 generates an induced current due to the rotation of the magnetic braking member 802.

A more specific example of a braking mechanism is shown in FIG. 2. The magnetic braking member 802 includes four permanent magnets. The magnetic braking member 802 is disposed on the winding reel shaft 202 through a connection part 803 in a method of rotating integrally with the winding reel shaft 202. The winding reel shaft 202 is disposed on the winding reel 200 in a method of rotating integrally with the winding reel 200. A plurality of magnetic poles of the magnetic braking member 802 are arranged in rotational symmetry with an axis of the winding reel shaft 202 as a center. Correspondingly, the braking coil 801 includes four single coils connected in series. The braking coil 801 is fixedly disposed on the fishing reel body 100 through a circuit board of a controller 900. The braking coil 801 is arranged opposite to the magnetic braking member 802 on an outer peripheral side of the magnetic braking member 802, and is arranged concentrically with the axis of the winding reel shaft 202.

It can be understood that in some examples, the braking coil 801 may also be configured as a rotor and the magnetic braking member 802 may also be configured as a stator, which is not limited herein. In some examples, the rotor may also be disposed on a side or other position of the winding reel 200, and correspondingly, the stator may be disposed at a position opposite to the rotor to form a power generation device, which is not limited herein. In some examples, one or more permanent magnets adopted in the magnetic braking member 802 and one or more single coils adopted in the braking coil 801 may be provided, which is not limited herein. In some examples, the braking coil 801 may also adopt a combination of a plurality of single coils connected in parallel or a mixed combination of series and parallel connection, which is not limited herein.

Some differences between the embodiments of the present application and the conventional technology are that the control method of the current in the braking coil 801 is improved. Specifically, the fishing line speed through the outlet guide ring is detected, and closed-loop control is performed based on the tangential speed and the fishing line speed through the outlet guide ring.

It can be understood that the structure illustrated in the embodiments of the present application does not constitute a specific limitation on the fishing reel or the braking device thereof. In some embodiments of the present application, the fishing reel or the braking device thereof may include more or fewer components than shown in the figure, or combine certain components, or split certain components, or arrange the components differently.

### OPTIMUM EMBODIMENTS OF THE PRESENT INVENTION

### Embodiment 1

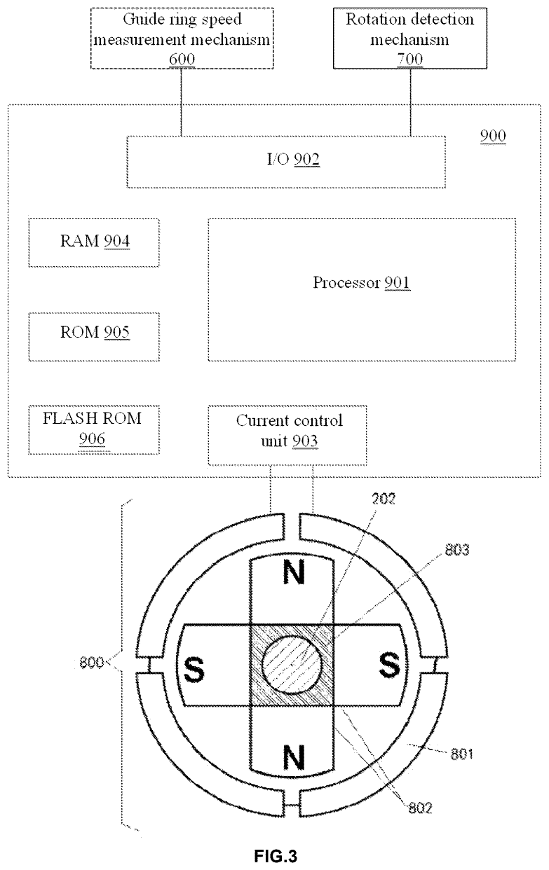

Embodiment 1 is a preferred embodiment of the present application. As shown in FIG. 3, in addition to the above braking mechanism 800, a fishing reel electromagnetic braking device according to an embodiment of the present application further includes: a guide ring speed measurement mechanism 600, a rotation detection mechanism 700, and a controller 900. Each part is described in detail as follows.

### (1) Guide Ring Speed Measurement Mechanism 600

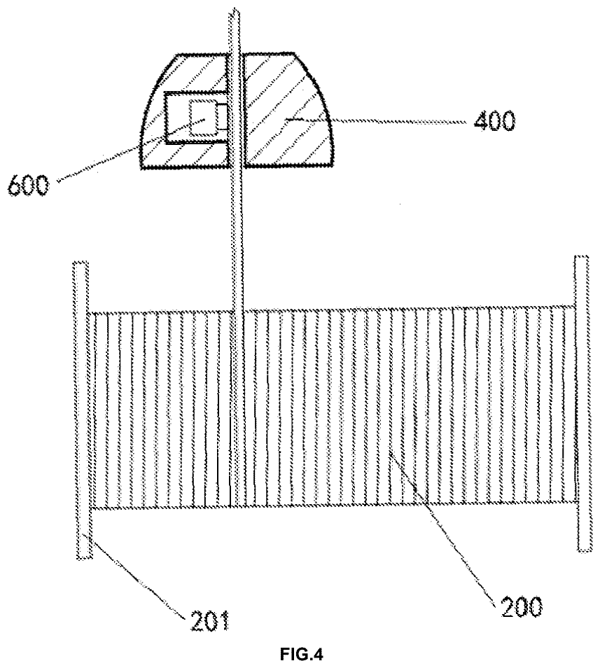

In the present embodiment, the guide ring speed measurement mechanism 600 is a linear speed sensor. As shown in FIG. 4, the linear speed sensor is embedded in an inner wall of the outlet guide ring 400 to detect speed information of a fishing line in the outlet guide ring and transmit the detected speed information of the fishing line to the controller 900.

It can be understood that the above linear speed sensor adopts commonly known technologies, such as a commonly used grating sensor, a magnetic grating sensor, an aberration speed sensor, etc., all of which can realize the detection of a linear speed or displacement.

The linear speed sensor is embedded in the inner wall of the outlet guide ring 400, which can make the fishing line pass smoothly in the outlet guide ring 400. The guide ring speed measurement mechanism 600 may also be disposed in the inner wall of the outlet guide ring 400 in a non-embedded method, which can also detect the speed information of the fishing line.

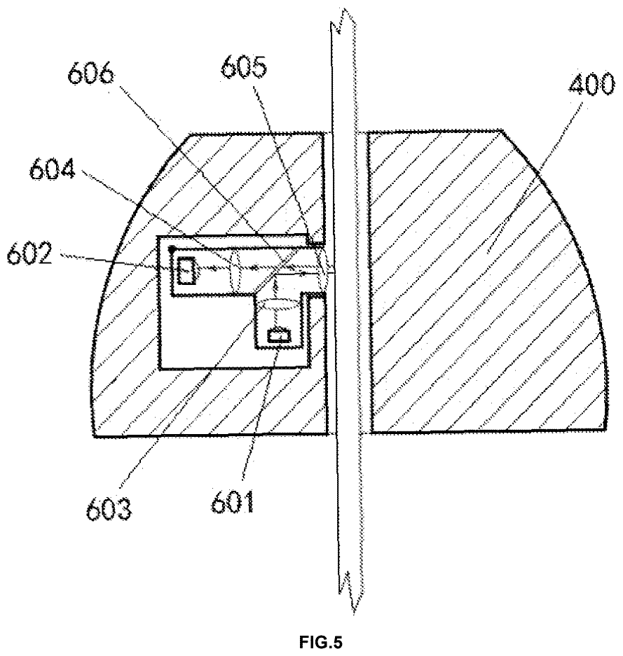

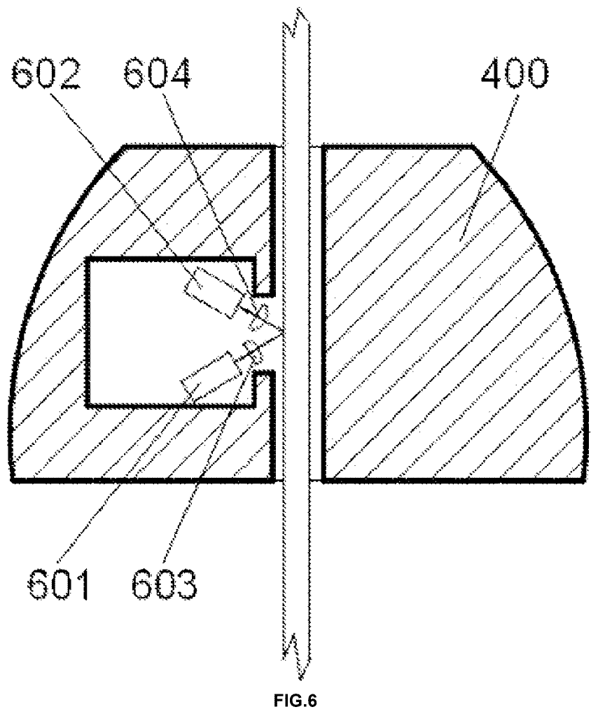

Specifically, in the present embodiment, the guide ring speed measurement mechanism 600 further includes a projection light source 601 and a light receiving part 602. The projection light source 601 is configured to emit light to the fishing line moving in the outlet guide ring 400, and the light receiving part 602 is configured to receive a reflected light signal of the fishing line. In some embodiments, the projection light source 601 and the light receiving part 602 may be separately provided or integrally combined. More specifically, as shown in FIG. 5, the projection light source 601, the light receiving part 602, and optical elements are combined. The light emitted by the projection light source 601 passes through a first lens 603, is reflected by a beam splitter 606, passes through a third lens 605, and illuminates the fishing line. The reflected light of the fishing line passes through the third lens 605, the beam splitter 606, and a second lens 604 and then reaches the light receiving part 602. Another optical path combination is shown in FIG. 6. The light emitted by the projection light source 601 passes through the first lens 603 and illuminates the fishing line. The reflected light of the fishing line passes through the second lens 604 and reaches the light receiving part 602. These similar optical combination methods are commonly known technologies, which are not limited herein.

In the present embodiment, the light receiving part 602 is a photoelectric sensor, which uses a fishing line spaced with color segments of different reflectivities with a first fixed marker length L. The light receiving part 602 can convert the detected reflected light signals into electrical pulse signals and is configured to calculate the fishing line speed V through the outlet guide ring of the fishing line.

The fishing line used in the present embodiment is shown in FIG. 15. In some embodiments, the first fixed marker length L is less than 0.85 m. In some embodiments, the first fixed marker length L is less than 0.3 m. In some embodiments, the first fixed marker length L is less than 0.1 m. In some embodiments, the first fixed marker length L is less than 0.05 m. It should be noted that the value of the first fixed marker length L can be adaptively set according to different application scenarios. The lower the value of the first fixed marker length L, the higher the detection accuracy, which is not limited in the present application.

It should be noted that using the reflected light of the signal marker to detect the displacement or speed is a commonly known technology, such as a widely used grating ruler, a grating positioning mouse, etc., which are specific applications.

### (2) Rotation Detection Mechanism 700

In the present embodiment, the rotation detection mechanism 700 includes a rotation speed sensor and a rotation direction detection device to detect rotation information of the winding reel 200. The rotation information includes information on a rotation pulse and a rotation direction. The rotation detection mechanism 700 is disposed on the fishing reel body 100, and transmits the detected rotation information to the controller 900.

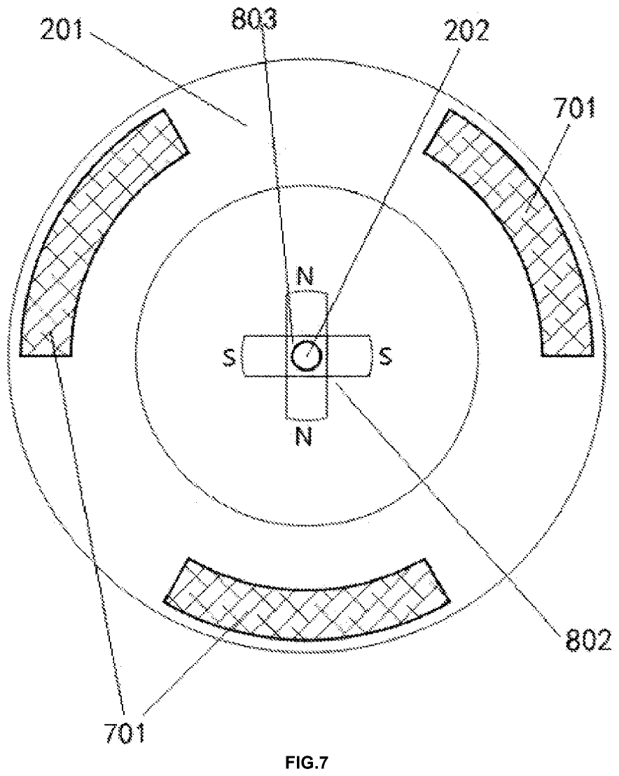

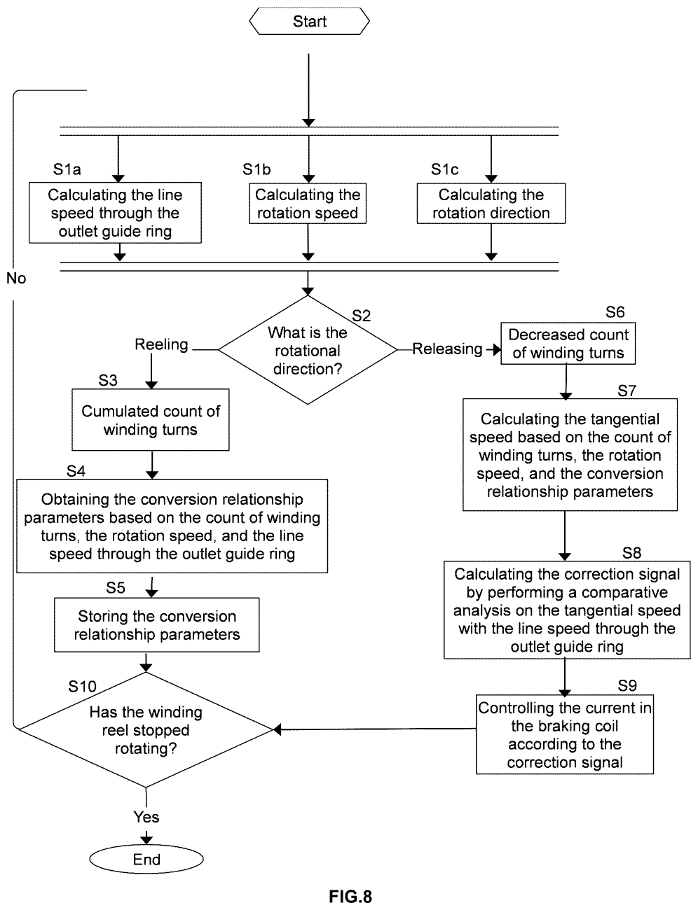

Specifically, the rotation detection mechanism 700 includes: a main rotation speed sensor configured to detect a rotation speed, and an auxiliary rotation speed sensor configured as a rotation direction detection device. The main rotation speed sensor and the auxiliary rotation speed sensor are both reflective photoelectric speed sensors and are fixed on the fishing reel body 100 through the circuit board of the controller 900. Detection directions of the main rotation speed sensor and the auxiliary rotation speed sensor point to a winding reel left side plate 201, and the main rotation speed sensor and the auxiliary rotation speed sensor form a certain central angle with a rotation center of the winding reel 200 as the center of a circle. As shown in FIG. 7, N rotation speed reflective markers 701 are provided on an outer side of the winding reel left side plate 201 at positions corresponding to the detection directions of the above-mentioned reflective photoelectric speed sensors. When the winding reel 200 rotates, the speed sensors emit light and detect reflected light signals of the rotation speed reflective markers 701 to generate rotation pulse signals. The rotation direction of the winding reel 200 is calculated based on a phase difference between the rotation pulse signals generated by the auxiliary rotation speed sensor and the main rotation speed sensor.

The number of the N rotation speed reflective markers is 3 (i.e., N=3). In some embodiments, the count of the rotation speed reflective markers (i.e., N) may also be any other natural number greater than 0, which is not limited in the present application. In some embodiments, a plurality of auxiliary rotation speed sensors and a plurality of main rotation speed sensors may be provided, which is not limited in the present application.

It should be noted that using sensors to detect rotation speed, rotation count, and rotation direction is a commonly known technology. In some embodiments, the above reflective photoelectric rotation speed sensors may also be replaced by other commonly known components such as a photoelectric detection device, a Hall sensor, a proximity switch, a contact switch, etc., which can be disposed at a position of the fishing reel body 100 capable of detecting the rotation information of the winding reel 200 to achieve the same function.

### (3) Controller 900

In the present embodiment, the circuit board of the controller 900 is disposed on an inner side of a left side cover of the fishing reel. As shown in FIG. 3, the controller 900 specifically includes: a processor 901, a memory, an I/O interface 902, and a current control unit 903. The memory includes an RAM 904, an ROM 905, and a flash memory (FLASH ROM) 906. The controller 900 is electrically connected with the guide ring speed measurement mechanism 600 and the rotation detection mechanism 700 through the I/O interface 902. The current control unit 903 is electrically connected with the braking coil 801.

In some embodiments, the controller 900 may be disposed at other appropriate positions in the fishing reel body 1, which is not limited in the present application. In some embodiments, the RAM 904, the ROM 905, and the flash memory (FLASH ROM) 906 may also be replaced by other commonly known memories with similar functions, such as using flash memory (FLASH ROM) to replace ROM, and using SRAM to replace DRAM, which is not limited in the present application.

The controller 900 is provided with a fishing line speed calculation module 912. The fishing line speed calculation module 912 is configured to calculate the fishing line speed V through the outlet guide ring based on an electrical pulse signal of the guide ring speed measurement mechanism 600 and the first fixed marker length L of the fishing line used.

The controller 900 processes the rotation information from the rotation detection mechanism 700 as follows.

Calculating the rotation direction of the winding reel 200 based on the phase difference between the two rotation pulse signals respectively generated by the auxiliary rotation speed sensor and the main rotation speed sensor of the rotation detection mechanism 700; calculating the rotation speed Vᵣ of the winding reel 200 based on the electrical pulse signals of the main rotation speed sensor; cumulatively counting a count of winding turns Nᵣ of the fishing line of the winding reel 200 based on one of the two rotation pulse signals; and recording the count of winding turns Nᵣ in the flash memory (FLASH ROM) 906. Specifically, when the fishing line is reeled, the recorded count of winding turns is increased by 1/N turns based on each electrical pulse signal, Nᵣ=Nᵣ+1/N, and when the fishing line is released, the recorded count of winding turns is decreased by 1/N turns based on each electrical pulse signal, Nᵣ=Nᵣ−1/N, where N denotes the count of the rotation speed reflective markers 701 in the rotation detection mechanism 700.

The controller 900 records and stores a corresponding conversion relationship parameter between the count of winding turns Nᵣ, the rotation speed Vᵣ, and the tangential speed Vₜ of the winding reel 200 in the flash memory (FLASH ROM) 906.

The conversion relationship parameter specifically refers to parameter data information used to calculate the corresponding tangential speed Vₜ based on the count of winding turns Nᵣ and the rotational speed Vₜ. According to commonly known mathematical and physical knowledge, the conversion relationship parameter is related to a geometric dimension of the winding reel 200 and a thickness of the fishing line used. Therefore, the conversion relationship parameter may be set and stored in advance, and may be expressed in the form of a parameter value, a regression model, a value table, or a combination thereof, which is not limited in the present application.

For example, an original diameter of the winding reel 200 is denoted as “D”. A fixed conversion coefficient K is defined between a thickness d of the fishing line wound by the winding reel 200 and the count of winding turns Nᵣ, i.e., d=K *Nᵣ. The relationship between the tangential speed Vₜ, the count of winding turns Nᵣ, and the rotation speed Vᵣ is expressed as “Formula 1”, that is:

Vₜ=π*(D+K*Nᵣ*2)*Vᵣ, where the diameter D and the coefficient K are the conversion relationship parameters.

The controller 900 is provided with a tangential speed calculation module 913. When the fishing line is released, the tangential speed Vₜ is calculated based on the count of winding turns Nᵣ of the winding reel 200, the rotation speed Vᵣ, and the conversion relationship parameters stored in the memory. For example:

the tangential speed Vₜ=π*(D+K*Nᵣ*2)*Vᵣ.

The current control unit 903 is a switching element, and a correction signal controls connection and disconnection of the switching element in an on/off switching method. The switching element specifically refers to an element or a combination of elements that controls connection and disconnection of the current by an input signal, such as a field effect transistor (FET), a switching triode, a thyristor, and other elements or a combination of elements, which is not limited in the present application.

The correction signal specifically refers to a signal for controlling an electromagnetic induction current of the braking coil 801 obtained by the following closed-loop control calculation.

### (4) Closed-Loop Control

The closed-loop control is shown in FIG. 11. The controller 900 is provided with a closed-loop control calculation module 911. A fishing line speed V through the outlet guide ring calculated by a fishing line speed calculation module 912 is used as a dynamic input target control quantity, and a tangential speed Vₜ calculated by a tangential speed calculation module 913 is used as an output controlled quantity, and the tangential speed Vₜ is used as a feedback quantity to calculate a correction signal for correcting the rotation speed of the winding reel. The correction signal controls the current in the braking coil 801 through the current control unit 903, so as to control a braking force on the winding reel 200, and then correct the rotation speed of the winding reel 200, thereby realizing closed-loop control to make the tangential speed Vₜ consistent with the fishing line speed V through the outlet guide ring.

A specific example of a simple closed-loop control mode is described. When the tangential speed Vₜ is greater than the fishing line speed V through the outlet guide ring, the correction signal is output to activate the current control unit 903, and the braking coil 801 generates the braking force on the winding reel 200 to decelerate; when the tangential speed Vₜ is less than or equal to the fishing line speed V through the outlet guide ring, the correction signal is output to deactivate the current control unit 903, and the braking coil 801 cancels the braking force on the winding reel 200 to stop decelerating, thereby realizing the closed-loop control.

The closed-loop control is a commonly known technology. In some embodiments, those skilled in the art may adopt other different closed-loop control algorithms or a combination of multiple closed-loop control algorithms, such as any one of a two-position control, a proportional control, an integral control, a differential control, a PID control, or the like, or any combination thereof, which is not limited in the present application.

The present embodiment dynamically detects the matching condition of the fishing line speed V through the outlet guide ring and the tangential speed Vₜ, and automatically corrects the rotation speed deviation of the winding reel, so as to realize the closed-loop control, thereby improving the braking stability of the fishing reel.

### EMBODIMENTS OF THE PRESENT INVENTION

### Embodiment 2

The following embodiment is implemented by replacing or improving upon the Embodiment 1. Only the replaced or improved parts are described below, and the same parts as the Embodiment 1 are not repeated. The parts inconsistent with the description in the Embodiment 1 are subject to the following description.

### (1) Improvement or Replacement of the Guide Ring Speed Measurement Mechanism and the Fishing Line Used

Under the premise that the structure of the guide ring speed measurement mechanism remains constant, the present embodiment can detect a relative fishing line speed through the outlet guide ring when a matched fishing line is used for fishing. The matched fishing line is provided with signal marker sequences with color segments of different reflectivity spaced apart. The light receiving part 602 converts detected reflected light signals into electrical pulse signals. The signal marker sequences match the geometric parameters of the winding reel, where the matching relationship is as follows: an interval length Lₓ of the signal marker sequences increases or decreases in proportion to an increase or a decrease of a winding diameter Dₓ of the fishing line on the winding reel, such that a ratio of the interval length Lₓ of the signal marker sequences to the corresponding winding diameter Dₓ meets a preset value Rᵣ, i.e., Rᵣ=Lₓ/Dₓ. The relative fishing line speed through the outlet guide ring of the fishing line passing through a line outlet and a relative tangential speed of the fishing line released by the winding reel can be calculated by detecting a count of signal markers M passing through the line outlet and a rotation angle A of the winding reel within the same time period T

As a specific example, when the rotation angle A of the winding reel is expressed in degrees (one circle is 360 degrees):
a speed at which the fishing line passing through the line outlet=M*Rᵣ*Dₓ/T;
a speed at which the fishing line is released by the winding reel=π*Dₓ*A/360°/T.

The two formulas are respectively divided by the winding diameter Dₓ to obtain the relative fishing line speed through the outlet guide ring and the relative tangential speed, i.e., a relative value with the winding diameter Dₓ as the unit of measurement. Where:
the relative fishing line speed through the outlet guide ring=M*Rᵣ/T; the relative tangential speed=π*A/360°/T.

Therefore, the relative fishing line speed through the outlet guide ring and the relative tangential speed can be calculated without calculating the winding diameter Dₓ or the count of winding turns. The relative fishing line speed through the outlet guide ring is treated as the fishing line speed V through the outlet guide ring, and the relative tangential speed is treated as the tangential speed Vₜ, such that the closed-loop control can be implemented.

As a more specific example, assuming that Rᵣ=2, the original diameter D of the winding reel is D=0.02 m, and then a signal marker interval of the fishing line at the start of winding is L₀=D*Rᵣ=0.04 m. The thickness of the wound fishing line is gradually increased. When the winding diameter is Dₓ, the signal marker interval Lₓ=Dₓ*Rᵣ=2Dₓ. For example, when the winding diameter Dₓ is 0.03 m, the signal marker interval is Lₓ=2Dₓ=0.06 m. In this way, the signal marker intervals on the fishing line are gradual, the fishing line and the winding reel are in a matching relationship, and the count of signal marks on the fishing line released when the winding reel rotates the same angle at any time is equal.

The above principle may also be implemented by other deformation alternatives. For example, when the rotation angle A is expressed in radians (one circle is 2TT), the relative tangential speed=A/2/T.

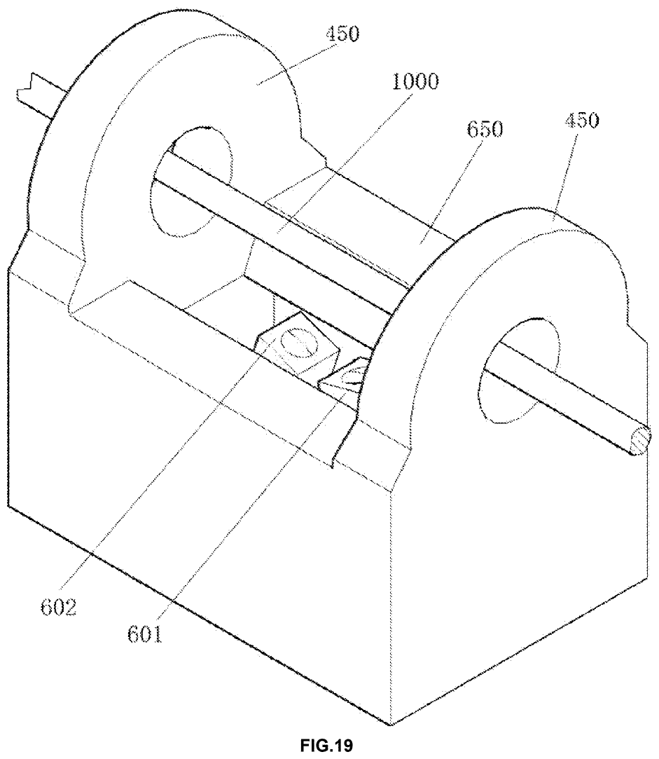

In addition, the linear speed sensor may also be disposed on a side of the outlet guide ring. As a specific example shown in FIG. 19, the linear speed sensor includes a projection light source 601 and a light receiving part 602. The linear speed sensor is disposed on a side of a guide ring 450 and connected with the guide ring as a whole through a housing of the linear speed sensor. The connection between the linear speed sensor and the guide ring is not limited to this method. For example, the connection between the linear speed sensor and the guide ring can be implemented through the fishing reel body or through a fishing rod. In a word, the guide ring guides a fishing line under test, and the fishing line speed through the outlet guide ring can be detected as long as the detection direction of the linear speed sensor points to the fishing line passing through the line outlet, and a measurable distance between the linear speed sensor and the fishing line under test is met, which is not limited in the preset application. The measurable distance refers to a range of distance between the linear speed sensor and the fishing line under test required to maintain a stable operation state. The measurable distance is determined by a specific application scenario. Those skilled in the art may determine the measurable distance based on theoretical calculations or empirical data, or may determine the measurable distance through a limited count of tests.

### (2) Improvement of the Rotation Detection Mechanism 700

The rotation detection mechanism 700 includes a rotation speed sensor configured to detect rotation information of the winding reel 200. The rotation information includes at least a rotation pulse. Rotation direction information is not necessary.

### (3) Improvement of the Controller 900

The fishing line speed calculation module 912 of the controller 900 calculates the relative fishing line speed through the outlet guide ring based on the electrical pulse signal of the guide ring speed measurement mechanism 600, and processes the relative fishing line speed through the outlet guide ring as the fishing line speed V through the outlet guide ring.

The controller 900 processes a rotation pulse signal generated by the rotation speed sensor of the rotation detection mechanism 700. Calculation of the rotation direction of the winding reel 200, the cumulated count of winding turns Nᵣ of the winding reel 200, or the corresponding conversion relationship parameter between the count of winding turns Nᵣ, the rotation speed Vᵣ, and the tangential speed Vₜ of the winding reel 200 is not required.

The tangential speed calculation module 913 of the controller 900 calculates the relative tangential speed based on the rotation pulse when the fishing line is released, and processes the relative tangential speed as the tangential speed Vₜ.

### (4) Improvement or Replacement of the Closed-Loop Control

The relative fishing line speed through the outlet guide ring is treated as the fishing line speed V through the outlet guide ring, and the relative tangential speed is treated as the tangential speed Vₜ, so as to realize the closed-loop control.

This embodiment can simplify the complexity of the rotation detection mechanism, simplify the processing course of the controller, and reduce parameter settings.

### Embodiment 3

The following embodiment is implemented by replacing or improving upon the Embodiment 1. Only the replaced or improved parts are described below, and the same parts as the Embodiment 1 are not repeated. The parts inconsistent with the description in the Embodiment 1 are subject to the following description.

### (1) Replacement of the Rotation Detection Mechanism 700

The rotation detection mechanism 700 is replaced with a reel aberration speed measurement device. The reel aberration speed measurement device is an aberration speed sensor, which is electrically connected with the controller 900 and disposed on the fishing reel body with a detection direction pointing to a surface fishing line of the winding reel. The reel aberration speed measurement device is configured to directly detect the tangential speed of the surface fishing line.

### (2) Improvement or Replacement of the Controller 900

The controller 900 does not need to process the rotation speed of the winding reel or related information, nor does it need to accumulate the count of winding turns Nᵣ of the winding reel 200. When the fishing line is released, the tangential speed calculation module 913 of the controller 900 directly calculates the tangential speed Vₜ based on a signal of the reel aberration speed measurement device.

This embodiment can simplify the complexity of the rotation detection mechanism, simplify the processing course of the controller, and reduce parameter settings.

### OTHER EMBODIMENTS

The following embodiments are provided by substitution, transformation, modification, or improvement performed based on the Embodiment 1, the Embodiment 2, or the Embodiment 3 without conflict. These embodiments and features in the embodiments may be combined with each other without conflict. The multiple embodiments and features in the embodiments may be combined to form a new embodiment. The following only describes the replacement, transformation or improvement parts, and the same parts as the original embodiment will not be repeated. For the parts inconsistent with the description in the original embodiment, the following description shall prevail.

(1) In some embodiments, the guide ring speed measurement mechanism 600 detects speed information and sends the speed information to the controller 900 for processing, which can be implemented in any of the following alternative methods:

For the Embodiment 1 or the Embodiment 3, an alternative embodiment is that the guide ring speed measurement mechanism 600 is specifically an aberration speed sensor, and further includes a projection light source 601 and a light receiving part 602. The light receiving part 602 is specifically an image sensor. Under the control of the controller 900, the image sensor picks up local image information reflected by the fishing line at a fixed time interval when the fishing line moves. Correspondingly, the fishing line speed calculation module 912 processes the image information of the guide ring speed measurement mechanism 600, performs before-and-after comparison analysis on the local images of the moving fishing line picked up at a certain time interval, and calculates the fishing line speed V through the outlet guide ring according to the distance moved by the local images at the set time interval. In this way, speed measurement can be implemented using an ordinary fishing line.

It should be noted that using the image information to detect displacement or speed is a commonly known technology. For example, the widely used laser mouse and the aberration speed sensor of TRANS-TEK in the United States are both applications of this commonly known technology.

For the Embodiment 1 or the Embodiment 3, another alternative embodiment is that the guide ring speed measurement mechanism 600 is a magneto-sensitive sensor. The fishing line is marked at intervals with magnetic signal markers each having a second fixed marker length L. The guide ring speed measurement mechanism 600 converts a detected magnetic signal into an electrical pulse signal. Correspondingly, the fishing line speed calculation module 912 calculates the fishing line speed V through the outlet guide ring based on the electrical pulse signal of the guide ring speed measurement mechanism 600 and the second fixed marker length L of the fishing line marked with the magnetic markers.

It should be noted that using the magnetic signal markers to detect the displacement or speed is a commonly known technology, such as applications of the widely used magnetic grating sensor and magnetic grating ruler.

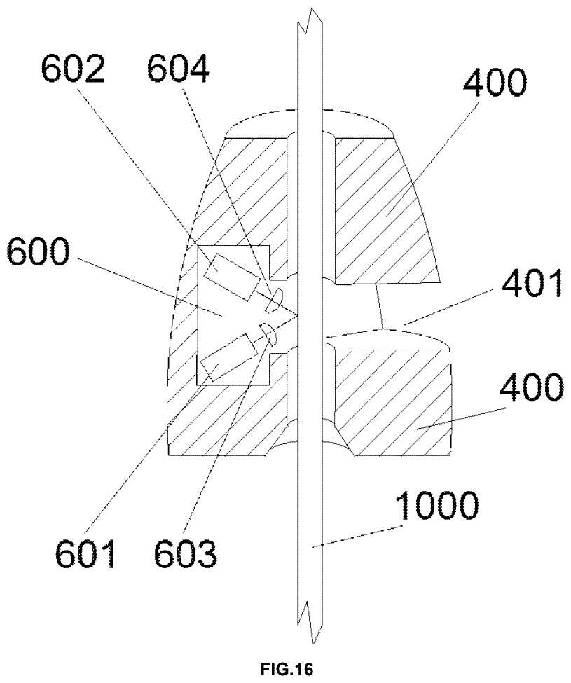

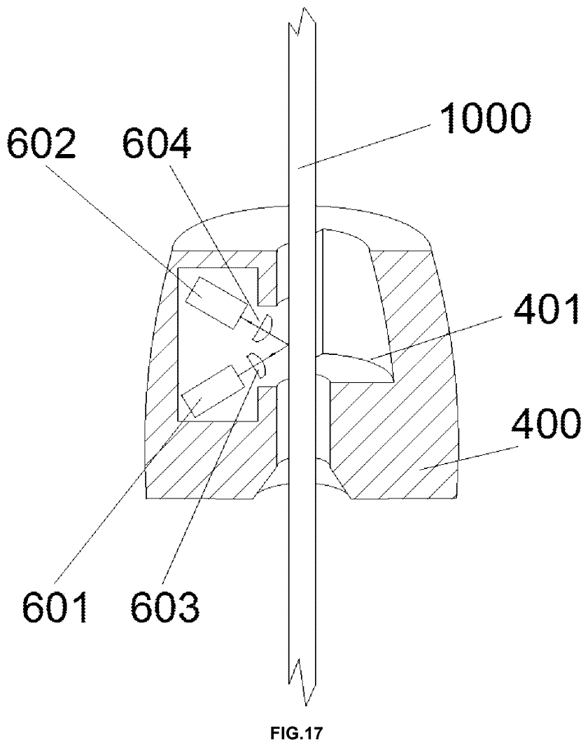

As shown in FIG. 16, the magnetic signal markers are specifically described as follows: a magnetic material is attached to the fishing line, and a series of magnetic signals are recorded at intervals of the second fixed marker length L. The arrangement of the magnetic poles is shown in FIG. 16, and the magneto-sensitive sensor can be a commonly known magnetic head. In some embodiments, the magneto-sensitive sensor may be a well-known Hall sensor or other device with similar functions. In some embodiments, the second fixed marker length L is less than 0.85 m. In some embodiments, the second fixed marker length L is less than 0.3 m. In some embodiments, the second fixed marker length L is less than 0.1 m. In some embodiments, the second fixed marker length L is less than 0.05 m. It should be noted that the value of the second fixed marker length L can be adaptively set according to different application scenarios. The lower the value of the second fixed marker length L, the higher the detection accuracy, which is not limited in the present application.

The manufacturing method of attaching the magnetic material to the fishing line can adopt a commonly known technology. For example, a magnetic tape for recording data, audio and video information is made by attaching a magnetic material to a flexible substrate. Such method can also be used to attach the magnetic material to the fishing line. As another example, magnetic material powder may be mixed with a liquid binder and then coated or impregnated on the fishing line or raw wire for producing the fishing line, such that the magnetic material can be attached to the fishing line.

For the Embodiment 2, there is another alternative embodiment that the guide ring speed measurement mechanism 600 is a magneto-sensitive sensor, the matched fishing line is provided with signal marker sequences with magnetic signal markers spaced at intervals, and the guide ring speed measurement mechanism 600 converts the detected magnetic signal into the electrical pulse signal. The signal marker sequences match the geometric parameters of the winding reel. The matching relationship is that the interval length Lₓ of the signal marker sequences increases or decreases in proportion to an increase or a decrease of the winding diameter Dₓ of the fishing line on the winding reel, satisfying that a ratio of the interval length Lₓ of the signal marker sequences to the corresponding winding diameter Dₓ meets the preset value Rᵣ, i.e., Rᵣ=Lₓ/Dₓ. Correspondingly, the fishing line speed calculation module 912 calculates the relative fishing line speed through the outlet guide ring and treats the relative fishing line speed through the outlet guide ring as the fishing line speed V through the outlet guide ring based on the electrical pulse signal of the guide ring speed measurement mechanism 600.

(2) In some embodiments, the method of controlling the electromagnetic induction current of the braking coil 801 in the controller is replaced by any of the following methods:

In an alternative manner, the current control unit 903 is specifically a switching element, which switches connection and disconnection of the electromagnetic induction current in the braking coil 801, and a correction signal controls a duration portion of connection and disconnection of the switching element by adjusting a PWM (pulse width modulation) signal duty cycle.

In another alternative manner, the current control unit 903 is a current intensity adjustment element, and the correction signal adjusts a current intensity in the current intensity adjustment element by adjusting an intensity.

The current intensity adjustment element specifically refers to an element or a combination of elements that controls the change of current intensity by an input signal, such as a field effect transistor, a triode, or other elements operating in a variable resistance region, or a combination thereof, or a circuit combination that realizes the function of a digital potentiometer, which is not limited in the present application.

(3) In some embodiments, the specific manner of closed-loop control may be replaced by any of the following manners:

An alternative manner, as shown in FIG. 12, calculating a difference ΔV=Vₜ−V between the tangential speed Vₜ and the fishing line speed V through the outlet guide ring. The controller 900 is provided with a difference ΔV calculation module 914. The ΔV calculation module 914 includes the fishing line speed calculation module 912 and the tangential speed calculation module 913. A preset allowable speed difference threshold Vₖ is used as an input target control quantity, and the above difference ΔV is used as an output controlled quantity and a feedback quantity.

For the replacement of the Embodiment 1 or the Embodiment 3, in some embodiments, the allowable speed difference threshold Vₖ is within a range of −0.1-1.0 m/s. In some embodiments, the allowable speed difference threshold Vₖ is within a range of −0.05-0.5 m/s. In some embodiments, the allowable speed difference threshold Vₖ is within a range of 0-0.2 m/s.

For the replacement of the Embodiment 2, in some embodiments, the allowable speed difference threshold Vₖ may be appropriately converted and adjusted. For example, the relative value conversion is performed using the original diameter D of the winding reel as the unit of measurement. For example, the allowable speed difference threshold Vₖ may select a value within a range of −5-50/s. It should be noted that the value of the allowable speed difference threshold Vₖ can be adaptively set according to different application scenarios, which is not limited in the present application.

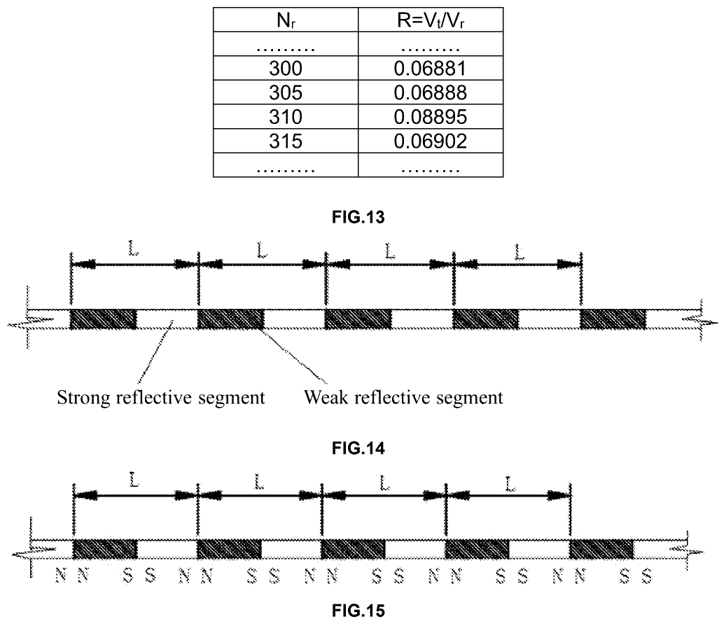

As another alternative manner, as shown in FIG. 13, the controller 900 is provided with a floating line length L_{f} calculation module 915. The L_{f} calculation module 915 includes the fishing line speed calculation module 912 and the tangential speed calculation module 913, and calculates an integral of the difference ΔV with respect to a line releasing time to obtain a floating line length L_{f} retained inside the fishing reel when the fishing line is released. A preset allowable floating line length threshold Lₖ is used as an input target control quantity, the floating line length L_{f} is used as an output controlled quantity, and the floating line length L_{f} is used as a feedback quantity.

The floating line length L_{f} refers to a length of the fishing line that is released from the winding reel 200, but is not pulled out of the outlet guide ring 400 and remains inside the fishing reel when the fishing line is released.

For the replacement of the Embodiment 1 or the Embodiment 3, in some embodiments, the allowable floating line length threshold Lₖ is within a range of 0-0.8 m. In some embodiments, the allowable floating line length threshold Lₖ is within a range of 0-0.5 m. In some embodiments, the allowable floating line length threshold Lₖ is within a range of 0.005-0.2 m.

As for the replacement of the Embodiment 2, in some embodiments, the allowable floating line length threshold Lₖ may also be appropriately converted and adjusted. For example, the relative value conversion is performed using the original diameter D of the winding reel as the unit of measurement. For example, the allowable floating line length threshold Lₖ may select a value is within a range of 0-40. It should be noted that the value of the allowable floating line length threshold Lₖ can be adaptively set according to different application scenarios, which is not limited in the present application.

The appropriate floating line length is maintained through the closed-loop control, so as to ensure that the fishing line is in a moderately relaxed state without being tangled, and prevent the braking system from consuming the inertial kinetic energy of the fishing bait, thereby achieving the effect of increasing the flight distance of the bait.

In some other alternative embodiments, for example, an integral value S of the fishing line speed V through the outlet guide ring for a time period Tₚ is calculated, an integral value Sₜ of the tangential speed Vₜ for the time period Tₚ is calculated, and a difference between the integral value S and the integral value Sₜ is calculated as a speed integral difference ΔS=Sₜ−S. The closed-loop control is implemented using a preset integral difference control value Sₖ as an input target control quantity, and a speed integral difference ΔS as an output controlled quantity and a feedback quantity. The above time period Tₚ is greater than or equal to a sampling period of the closed-loop control, and the Tₚ is less than or equal to the line releasing time. In addition, the Tₚ may take a fixed value or a dynamic value. The value of the Tₚ may be determined by those skilled in the art based on a limited count of tests, which is not limited in the present application.

The above equivalent replacements are easily conceived by those skilled in the art, and the closed-loop control achieved by the above manners does not deviate from the spirit and protection scope of the present application.

(4) For the Embodiment 1, in some embodiments, the detection of the rotation direction may also be implemented by any of the following rotation direction detection devices.

In one alternative manner, the rotation direction detection device is an auxiliary rotation speed sensor provided on the fishing reel body. The controller calculates the rotation direction of the winding reel based on a phase difference between rotation pulse signals respectively generated by the auxiliary rotation speed sensor and the main rotation speed sensor.

In another alternative manner, the rotation direction detection device is a state detection element disposed on the fishing reel body. The state detection element may detect the change of a position or a movement of a mechanical part of the fishing reel using a commonly known switching element such as a Hall switch, a contact switch, a proximity switch, etc., and determine the rotation direction of the winding reel according to a generated detection signal. It is a commonly known technology to detect the position or the movement of the mechanical part and convert the detected position or the movement information of the mechanical part into an electrical signal. For example, a magnet is disposed at a bottom of a button of the clutch switch 300, and a Hall switch is disposed on the fishing reel body 100 relative to the position of the magnet to detect the operation state of reeling and releasing.

In another alternative manner, the rotation direction detection device is implemented by a threshold comparison unit. The threshold comparison unit reads an absolute value of any one of the rotation speed, the tangential speed, or the fishing line speed through the outlet guide ring of the winding reel, or a change rate thereof, and determines whether the winding reel is in a line releasing state based on whether it is detected that the read parameter is greater than a corresponding preset threshold. Since the winding reel 200 rotates at a high speed at the beginning of casting the bait and rotates at a low speed when the line is reeled, if the absolute value of the read speed value is higher than the corresponding preset threshold, the threshold comparison unit determines that a bait casting and line releasing state is entered. Thereafter, when the continuous line outlet process is detected to stop, the bait casting and line releasing state is ended and switched to a line reeling state; or, as another alternative, since the rotation speed Vᵣ or the tangential speed Vₜ or the fishing line speed V through the outlet guide ring of the winding reel has an instantaneous high change rate at the beginning of casting the bait, the threshold comparison unit may also determine whether the bait casting and line releasing state is entered by detecting whether the change rate is higher than the corresponding preset change rate threshold.

The threshold of the rotation speed is within a range of 5 rps-500 rps. In some embodiments, threshold of the rotation speed is within a range 50 rps-100 rps. In some embodiment, the threshold of the tangential speed Vₜ or the threshold of the fishing line speed V through the outlet guide ring is within a range of 0.5 m/s-50 m/s. In some embodiment, the threshold of the tangential speed Vₜ or the threshold of the fishing line speed V through the outlet guide ring is within a range of 5 m/s-10 m/s. The preset threshold of the above parameter or the preset threshold of the above parameter change rate can be set according to different application scenarios, or those skilled in the art can select the value based on a limited count of tests, which is not limited in the present application.

A circuit of the threshold comparison unit is electrically connected with the controller 900 and can be disposed on the fishing reel body 100. As an optional manner, the circuit of threshold comparison unit may also be integrated into a circuit of the controller 900, which is not limited in the present application. Using the threshold comparison method to detect the rotation direction can reduce the system complexity, improve the reliability, and save the manufacturing cost.

In an alternative manner, the rotation direction detection device is implemented by an acceleration sensor disposed on the fishing reel body, and the acceleration sensor is electrically connected with the controller. Whether the fishing reel is in the line releasing state is determined based on whether the detected acceleration is greater than a preset acceleration threshold. Since the fishing rod and the fishing reel are swung when casting the bait, and the acceleration sensor is electrically connected with the controller 900, when the acceleration is detected to be greater than the preset acceleration threshold, it is determined to enter the bait casting and line releasing state. Thereafter, when the continuous line outlet process is detected to stop, the bait casting and line releasing state is ended and switched to the line reeling state. The preset acceleration threshold may be determined according to a specific application scenario, or determined by those skilled in the art based on a limited count of tests, which is not limited in the preset application.

In another alternative manner, when the guide ring speed measurement mechanism 600 is provided with an aberration speed sensor, the rotation direction detection device can be implemented by the aberration speed sensor. The rotation direction of the winding reel 200 is determined according to a moving direction of the fishing line detected by the aberration speed sensor. The reliability can be improved by using the aberration speed sensor which also serves as the rotation direction detection device.

In another alternative method, when the main rotation speed sensor has the function of detecting the rotation direction, the main rotation speed sensor can also be used as the rotation direction detection device to improve the reliability. The above-mentioned rotation speed sensor with the function of detecting the rotation direction can be implemented through specific devices such as the aberration speed sensor, a rotary transformer, etc., and the method disclosed in the Chinese Patent Application CN201821109629.X: providing at least two detection markers of different sizes arranged at intervals on a rotation object under test; and the detection sensor, configured to be in contact with or non-contact with the rotation object under test, determines the rotation direction according to a detected signal width sequence.

In a word, the rotation direction detection device can be implemented by any commonly known method for detecting the rotation direction of the winding reel, can also be implemented by any commonly known method for detecting the mechanical state of the fishing reel when releasing or reeling the line, can also be implemented by any commonly known method for detecting the acceleration information of the fishing reel when casting or reeling in the line, and can also be implemented by any commonly known method for detecting the speed information of the fishing line or the rotation speed of the winding reel.

(5) For the Embodiment 1, in some embodiments, the controller 900 processes and stores the conversion relationship parameters in the following manner.

The conversion relationship parameters corresponding to various thicknesses of fishing lines are stored in a memory in advance, and a selection button is provided on the fishing reel body 100 and electrically connected with the controller 900. During fishing, the matched conversion relationship parameter is selected and set using the selection button. Or the controller 900 is further provided with a wireless communication module for wireless communication with an external setting terminal. During fishing, the matched conversion relationship parameter is selected and set using the external setting terminal.

The selection button specifically refers to: a knob with a scale indicator dial, which is rotated to different positions to set different circuit parameters or set different line connection manners; and an equivalent device that achieves the same function as mentioned above by pressing a button, such as a station selection knob or button of a radio, a gear selection knob or button of a microwave oven or washing machine, or other similar devices. The wireless communication may be implemented in the form of WIFI, Bluetooth, NFC, or other modes. The external setting terminal may include a smartphone APP, a wireless remote control, or the like, which is not limited in the present application.

Since commonly used fishing line parameters are stored in advance, the matched parameter can be selected in use, which further simplifies the complexity of setting parameters.

(6) Regarding the Embodiment 1, in some embodiments, the controller 900 automatically calculates and stores the conversion relationship parameter in any of the following manners:

In one processing method, for the case that an inner side of a side plate of the winding reel 200 is a plane, since the tangential speed Vₜ when the winding reel 200 reels the fishing line is equal to the fishing line speed V through the outlet guide ring, a plurality of sample data including the fishing line speed V through the outlet guide ring, the count of winding turns Nᵣ, and the rotation speed Vᵣ calculated at different time points are taken to form a data sample group. Any two data samples in the data sample group are substituted into the exemplary formula 1, i.e.:

Vₜ=π*(D+K*Nᵣ*2)*Vᵣ, and a set of two-variable linear equations can be obtained. At least one set of equations is used to obtain at least one pair of diameter D and coefficient K. The mean values of the diameter D and the coefficient K are obtained based on statistical processing and stored in the memory. A plurality of data samples is collected for calculation, and the mean value is obtained by performing statistical processing on the result to reduce the detection error.

In the above embodiment, the diameter D is solved as an unknown parameter, so it can be used as a starting position for counting the count of winding turns when a certain amount of fishing line remains on the winding reel 200. For the case where the bare reel is used as the starting position for counting the count of winding turns, since a bare diameter D of the winding reel is a fixed value, in some embodiments, the bare diameter is used as a constant to replace the diameter D in the above embodiment to obtain a linear equation. Therefore, at least one data sample is required to establish one equation to obtain the coefficient K.

For a non-planar geometric shape such as the inner side of the side plate of the winding reel 200 being inclined or arc-shaped, the equivalent functional effect can be achieved by simply modifying the corresponding calculation formula according to known geometric knowledge. For example, in the embodiment that the inner side of the side plate of the winding reel 200 is a conical surface or a rotational curved surface, a surface width Wₓ of a wound fishing body of any thickness is a distance between left and right side plates at a surface of the wound fishing body, and the relationship between the surface width Wₓ and a diameter x of the wound fishing body is a known function.

$${W}_{x} = f ( x ) \qquad [ number 1 \_sm \_ 0001 ]$$

this functional relationship is only related to the geometric characteristics of the generatrix of the conical surface or the rotational curved surface. The relationship between the cross-sectional area coefficient Kₛ of each turn of fishing line in the wound fishing body, the count of winding turns Nᵣ, the original diameter D, and a winding thickness d is denoted as “Formula 2”, i.e.:

$${\int }_{D}^{D + 2 d} f ( x ) dx = 2 {K}_{s} N \qquad [ number 1 \_sm \_ 0002 ]$$

In this case, the relationship between the tangential speed Vₜ, the original diameter D, the winding thickness d, and the rotation speed Vᵣ is denoted as “Formula 3”, that is:

Vₜ=π*(D+d*2)*Vᵣ, where the coefficient Kₛ and the original diameter D are the conversion relationship parameters. When the winding reel 200 releases the line, the tangential speed Vₜ can be calculated according to Formula 2 and Formula 3. In some embodiments, when the winding reel 200 reels the line, sample data of the tangential speed Vₜ, the count of winding turns Nᵣ, and the rotational speed Vᵣ are substituted into the above Formula 2 and Formula 3 to calculate the output coefficient Kₛ and the diameter D. The coefficient Kₛ and the diameter D are used as the conversion relationship parameters that are automatically stored.

In another processing method, the above method of automatically calculating and storing the conversion relationship parameters is replaced by, when reeling the fishing line, taking the tangential speed Vₜ as a dependent variable, taking the count of winding turns Nᵣ and the rotational speed Vᵣ as independent variables to establish a regression equation, taking a plurality of sample data including the fishing line speed V through the outlet guide ring, the count of winding turns Nᵣ, and the rotational speed Vᵣ measured at different time points to form a data sample group to perform regression analysis, and storing a regression model and the parameters as the conversion relationship parameters in a read-write memory. When the fishing line is released, the tangential speed calculation module 913 inputs the count of winding turns Nᵣ and the rotational speed Vᵣ into the regression model to calculate the tangential speed Vₜ.

In another processing method, the above method of automatically calculating and storing the conversion relationship parameters is replaced by, when reeling the fishing line, calculating a conversion ratio r of the tangential speed Vₜ to the rotational speed Vᵣ corresponding to different winding turns Nᵣ, specifically r=Vₜ/Vᵣ, as shown in FIG. 14, and making a conversion relationship table for a series of the winding turns Nᵣ and the conversion ratios r corresponding to the winding turns Nᵣ, and storing the conversion relationship table in the memory. When the fishing line is released, the tangential speed calculation module 913 queries the corresponding ratio r in the conversion relationship table according to the count of winding turns Nᵣ, and then calculates the tangential speed Vₜ=r*Vᵣ according to the rotational speed Vᵣ.

The conversion relationship parameters are automatically calculated and stored, such that the effect of precise control of braking without preset operations can be achieved.

(7) According to the embodiment described in section (6), in some embodiments, the controller 900 determines whether to execute the processing step of calculating and storing the conversion relationship parameters when the fishing reel reels the fishing line in any of the following methods:

In one embodiment, the above processing steps are automatically performed each time the fishing line is reeled.

Another determination method is that the fishing reel body is provided with a setting button electrically connected with the controller, and the setting button is configured to control whether to execute the above processing steps; or, the controller 900 is further provided with a wireless communication module that is in wirelessly communication with an external operation terminal, and the external operation terminal is configured to control whether to execute the above processing steps; when the fishing line is replaced with a new one or the conversion relationship parameters need to be refreshed, an operator sends a signal to the controller to re-execute the above processing steps through a setting method. The external operation terminal may include a smartphone APP, a wireless remote control, or the like, which is not limited in the present application.

Another determination method is that when the count of the winding turns of the winding reel is detected to be less than a turn threshold or the conversion relationship parameters are detected not stored, the above processing steps are executed. When the fishing line is replaced with a new one or the fishing line needs to be rewound, if the count of winding turns is less than the turn threshold, the above processing steps are executed. In some embodiments, the turn threshold is within a range of 0-1200 turns. In some embodiments, the turn threshold is within a range of 0-300 turns. In some of the embodiments, the turn threshold is within a range of 0-50 turns. In some embodiments, the turn threshold is within a range of 0-10 turns. It should be noted that the value of the turn threshold can be adaptively set according to different application scenarios, which is not limited in the present application.

(8) In some embodiments, the guide ring speed measurement mechanism 600 is implemented in the following method:

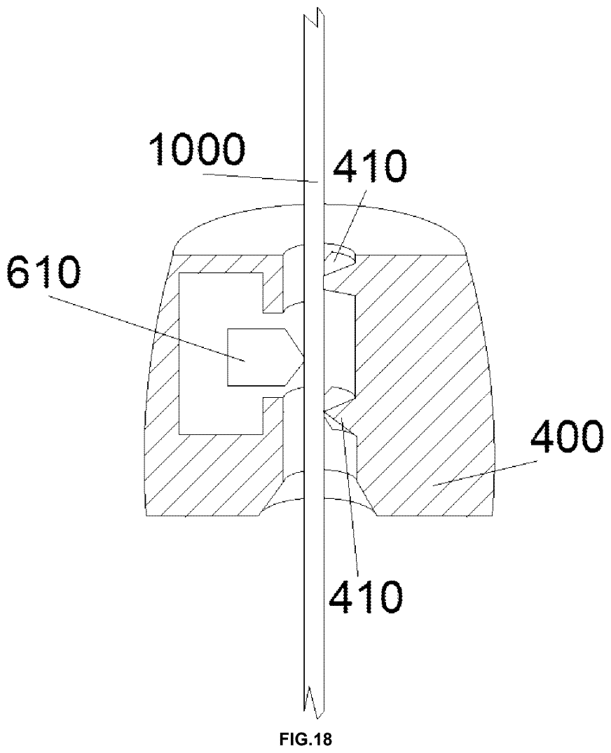

When the linear speed sensor is provided with a photoelectric sensor or an image sensor, a light escape notch 401 is disposed between two ends or at an end of the outlet guide ring 400, and a detection direction of the linear speed sensor exactly faces the light escape notch 401. The light escape notch 401 may be an open hole penetrating a wall of the outlet guide ring, or may be a non-penetrating recess on an inner wall of the outlet guide ring. FIG. 17 is a schematic cross-sectional view of an open hole disposed between two ends of an outlet guide ring. FIG. 18 is a schematic cross-sectional view of a recess disposed at an end of an outlet guide ring. The light escape notch 401 is provided to reduce light reflection from a background part of the detected fishing line, so as to reduce the interference of the light reflected from the inner wall of the outlet guide ring 400 on a fishing line signal picked up by the light receiving part 602, thereby improving the stability of the fishing line signal picked up by the light receiving part 602. According to this principle, those skilled in the art can realize light escape notches in various different positions, shapes or structural forms.

When the linear speed sensor is implemented by a magneto-sensitive sensor, the linear speed sensor is a magnetic head 610 protruding from the inner wall of the outlet guide ring 400. A positioning support 410 is arranged inside the outlet guide ring. The positioning support 410 maintains a clearance between the fishing line in the outlet guide ring and the magnetic head 610 at 0 or maintains a stable operation clearance. In some embodiments, the specific value of the operation clearance is within a range of 0-2 mm. The value of the operation clearance can be adaptively set according to different application scenarios. Those skilled in the art can also determine the appropriate value based on a limited count of tests, which is not limited in the present application. At least one positioning support 410 is provided, and the at least one positioning support 410 can be implemented in various ways. For example, the positioning support 410 can be formed by a protruding portion of the inner wall of the outlet guide ring 400, or the positioning support 410 can be formed by a support that prevents the fishing line from moving away from the magnetic head 610 and is fixed inside the outlet guide ring 400, which is not limited in the present application. A specific positioning support is shown in FIG. 19. The positioning support 410 is configured to cooperate with the magnetic head 610 protruding from the inner wall of the outlet guide ring 400 to maintain the clearance between the fishing line and the magnetic head 610 at 0 or maintain a stable operation clearance, so as to improve the stability of the magnetic head 610 in reading the magnetic signal. According to this principle, those skilled in the art can realize positioning supports in various different positions, shapes or structural forms.

(9) For the Embodiment 1 or the Embodiment 2, in some embodiments, the main rotation speed sensor of the rotation detection mechanism can be implemented by a photoelectric sensor, a Hall sensor, an aberration speed sensor, an electromagnetic sensor, or an inductive sensor. The electromagnetic sensor specifically refers to a sensor that obtains a signal based on an induced electromotive force of the detection coil. The inductive sensor specifically refers to a sensor that obtains a signal based on a change in inductance or inductive reactance of the detection coil.

In the case where the main rotation speed sensor of the rotation detection mechanism is the electromagnetic sensor or the inductive sensor, at least one single coil of the braking coil 801 can be used as a speed measurement coil. The controller 900 is electrically connected with the speed measurement coil. A rotor position signal of the winding reel is calculated based on an electrical signal containing rotor position information in the speed measurement coil, and a rotation pulse signal is extracted based on the rotor position signal, which is implemented in the following method:

In the case where the main rotation speed sensor is the electromagnetic sensor, due to the change of magnetic flux in the speed measurement coil when the rotor rotates at different positions, the induced electromotive force is generated, and the rotor position signal of the winding reel is calculated based on a signal of the induced electromotive force generated in the speed measurement coil;

In the case where the main rotation speed sensor is the inductive sensor, due to the salient pole effect, the inductance of the speed measurement coil changes when the rotor is at different rotation positions. The controller 900 injects a high-frequency voltage signal into the speed measurement coil, and a high-frequency current in the speed measurement coil responds to a change of inductance. A high-frequency current response caused by the salient pole is detected and the rotor position signal is decoupled. In some embodiments, the high-frequency voltage can be selected within a range of 50 mV-2000 mV, and the frequency of the high-frequency voltage can be selected within a range of 100 Hz-50 KHz. It should be noted that appropriate values of the voltage and frequency parameters are selected according to different application scenarios, or selected by those skilled in the art based on a limited count of tests, which is not limited in the present application.

By using the detection mode based on the electromagnetic sensor or the inductive sensor, part or all of the single coils of the braking coil can be used as the rotation speed sensor, which can reduce the system complexity, improve the reliability, and save the manufacturing cost.

Detecting the induced electromotive force or the inductive impedance of the motor coil to detect the position signal of the motor rotor is a traditional and well-known detection technology. For example, the detection method is widely used in rotor position detections of tachometer generators, rotary transformers, and brushless motors, etc. Specific methods include a method of electromotive force detection or high frequency injection. For those skilled in the art, detecting the motor rotor position signal according to the above principle and extracting information such as the rotation pulse and the rotation speed are all commonly known conventional technologies.

In some embodiments, when the auxiliary rotation speed sensor is used as a rotation direction detection device, the auxiliary rotation speed sensor can be implemented by a photoelectric sensor, a Hall sensor, an electromagnetic sensor, or an inductive sensor.

(10) In some embodiments, the guide ring speed measurement mechanism 600 can also be implemented by a following line speed measurement device.

FIG. 19 shows a line speed measurement device of an embodiment of the present application. A linear speed sensor includes a projection light source 601 and a light receiving part 602. Guide rings 450 are respectively provided on two sides of a detection window of the linear speed sensor. The linear speed sensor and the guide rings are fixedly assembled on a connection device. A measured line passes through the guide rings, and the measured line is guided by the guide rings such that a measurable distance is maintained between the measured line and the linear speed sensor. The above measured line is a fishing line, and the above line speed measurement device is equivalent to the guide ring speed measurement mechanism 600.

Where the “fixedly assembled” specifically refers to a connection method in which the components are fixedly connected by one or more of a threaded connection, a snap connection, a rivet connection, a hoop connection, a bundling connection, welding, gluing or inlay connection, and the connected components cannot move relative to each other, including a detachable connection and/or a non-detachable connection; the “fixed assembly” also includes a manufacturing method in which a plurality of components are integrally cast, integrally injected or integrally stamped, etc.; the “fixed assembly” further includes a screw drive connection, in which a nut and a screw maintain a relatively fixed position relationship in a speed measurement operation state.

The “connection device” specifically refers to a combination of one or more components, which carries a plurality of functional components fixedly assembled thereon, and the assembled functional components maintain a relatively fixed positional relationship in the speed measurement operation state.

The “measurable distance” refers to a range of distance between the linear speed sensor and the measured line required to maintain a stable operation state. The measurable distance is determined by a specific application scenario. Those skilled in the art may determine the measurable distance based on theoretical calculations or empirical data, or may determine the measurable distance through a limited count of tests.

In the present embodiment, the guide rings can be directly disposed on the housing of the linear speed sensor. The housing of the linear speed sensor serves as the connection device. The linear speed sensor and the guide rings are fixedly connected as a whole through the housing. In some embodiments, the linear speed sensor may further include a light transmission sealing component in the detection window to protect the detection element.

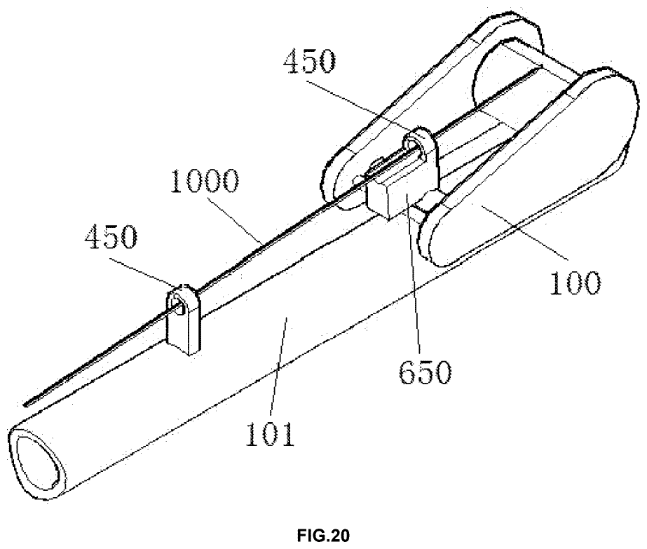

In addition, as shown in FIG. 20, the guide ring on a first side can be fixedly assembled on a fishing rod. The linear speed sensor and the guide ring on a second side can be fixedly assembled as a whole and then fixedly assembled on the fishing reel; or, the linear speed sensor and the guide ring on the second side can also be fixedly assembled on the fishing reel body respectively, with the fishing rod and the fishing reel body serving as the connection device. In addition, the linear speed sensor and the guide rings may be fixedly mounted on the fishing rod, respectively, with the fishing rod serving as the connection device.

In a word, as long as the linear speed sensor and the guide rings maintain a relatively fixed position relationship in a speed measurement operation state, the guide rings on the two sides of the detection window of the linear speed sensor guide the measured line to maintain the measurable distance between the measured line and the linear speed sensor, the function of the line speed measurement device can be realized. Under the condition that the above requirements are met, the linear speed sensor and the guide rings can be flexibly combined and configured through the connection device, which can be realized by those skilled in the art.

### [Controller 900 Processing Flowchart]

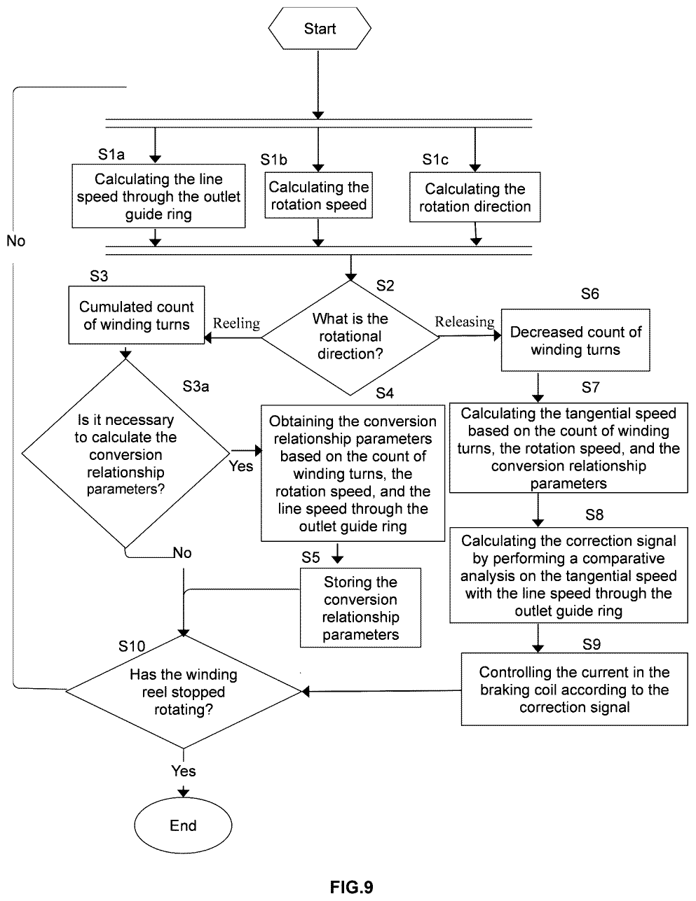

As shown in FIG. 9, the controller 900 of some embodiments of the present application processes according to the following process:
Firstly, when the operation starts, the winding reel 200 rotates. Step S1a is executed to calculate the ring speed V according to the speed information of the guide ring speed measurement mechanism 600. At the same time, step S1b is executed to calculate the rotation speed Vᵣ of the winding reel 200 according to the electric pulse signal of the rotation detection mechanism 700, and step S1c is executed to detect the rotation direction of the winding reel 200;
After step S1a, step S1b, and step S1c are executed in parallel, the process proceeds to step S2 to determine the rotation direction of the winding reel 200;
If the rotation direction of the winding reel 200 is to reel the line, the process proceeds to step S3, where the count of winding turns Nᵣ is cumulated in the memory. Then, the process proceeds to step S4, where the conversion relationship parameters are obtained according to the count of winding turns Nᵣ, the rotation speed Vᵣ, and the fishing line speed V through the outlet guide ring. Subsequently, the process proceeds to step S5, where the above conversion relationship parameters are stored in the memory;
If the rotation direction of the winding reel 200 is determined to release the line in step S2, the process proceeds to step S6, where the count of winding turns Nᵣ is cumulatively decreased in the memory;
Then, the process proceeds to step S7, where the tangential speed Vₜ is calculated based on the count of winding turns Nᵣ, the rotation speed Vᵣ, and the corresponding conversion relationship parameters;
Then, the process proceeds to step S8, where a correction signal is calculated by comparing the tangential speed Vₜ with the fishing line speed V through the outlet guide ring;
Then, the process proceeds to step S9, where the current in the braking coil 801 is controlled according to the correction signal to enable control of a braking force;
After step S5 or step S9 is completed, the process proceeds to step S10 to determine whether the winding reel 200 stops rotating;
If the winding reel 200 has not stopped rotating, the process re-enters the parallel steps S1a, S1b, and S1c to initiate the next control cycle. Otherwise, if the winding reel 200 has stopped rotating, the process ends.

### Processing Flowchart of Other Embodiments

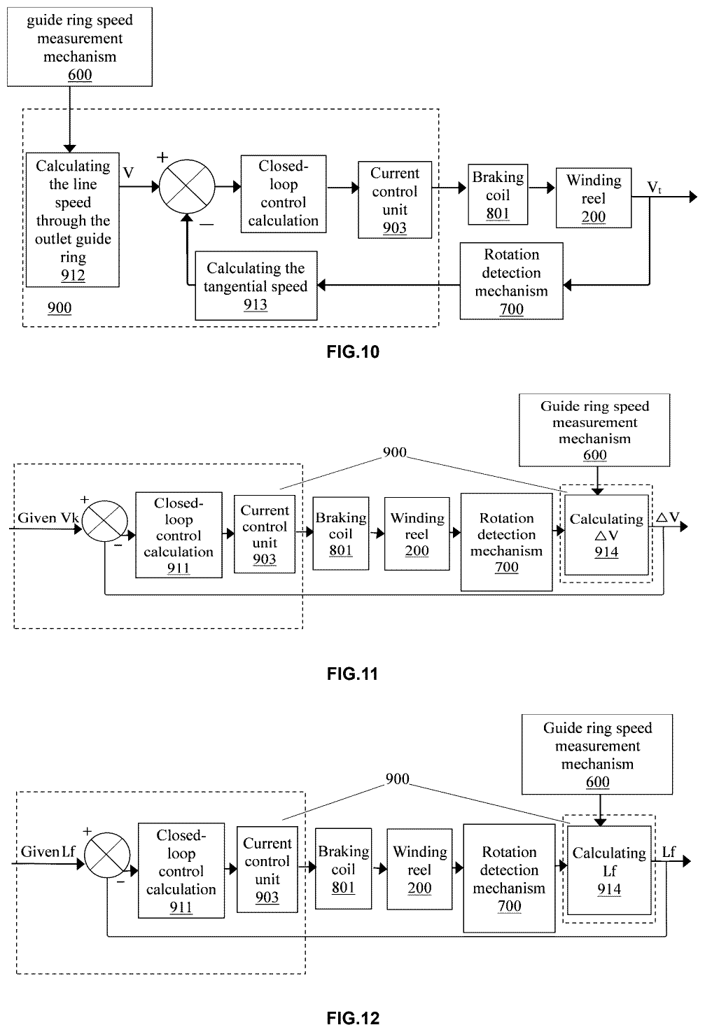

As shown in FIG. 10, based on the above flowchart, step S3a is added between step S3 and step S4 to determine whether to calculate the conversion relationship parameters;

If the conversion relationship parameters need to be calculated, the process proceeds to step S4;

If the conversion relationship parameters do not need to be calculated, the process proceeds to step S10.

In some embodiments, step S1a can be omitted when the fishing line is reeled. That is, the fishing line speed V through the outlet guide ring does not need to be calculated when the fishing line is reeled, so as to reduce the processor workload and reduce energy consumption.

### OTHER DESCRIPTION

The steps and/or operations in the flowcharts and drawings described in the present specification are only for illustrative purposes. In addition to the above-mentioned examples, these steps and/or operations may be subject to many variations without departing from the spirit of the present application. For example, the steps may be performed in a different order, or steps may be added, deleted or modified, or the execution content of the blocks may be modified.

Obviously, the present application is not limited to the precise structure described above and shown in the accompanying drawings. The embodiments described above are only a part but not all of the embodiments of the present application. On the contrary, the embodiments of the present application include all changes, modifications, substitutions, variations, and equivalents that fall within the spirit and scope of the attached claims. The parameters and variables are merely examples used to illustrate the concept principle of the present application. Those skilled in the art can equivalently transform the parameters into other parameters and variable expressions based on commonly known mathematical and physical knowledge to achieve the same function without departing from the scope of the present application.

All of the left, right, front and rear directional descriptions of the embodiments of the present application are based on a fishing reel with a right crank handle from the operator's perspective, as an example. For the fishing reel with a left crank handle, the same function can be achieved by simply swapping the “left” and “right” in the description of the embodiments.

It should be understood that the functional modules, components, steps or schematic blocks disclosed in the embodiments of the present application can be implemented using hardware, software, firmware or a combination thereof, and do not necessarily refer to specific hardware or software components that can be physically separated. Each functional unit may be integrated into one processing module, or each unit may exist physically separately, or two or more units may be integrated into one module.

In the embodiments of the present application, one or more components or steps may be implemented using software or firmware stored in a memory and executed by a suitable instruction execution system. For example, in one embodiment, it is implemented by hardware; in another embodiment, it can also be implemented by executing a program in a memory using any one of the following technologies known in the art or a combination thereof: a discrete logic circuit having a logic gate circuit configured to implement a logic function on a data signal, a dedicated integrated circuit having a suitable combination of logic gate circuits, a general-purpose processor (CPU), a programmable gate array (PGA), a field programmable gate array (FPGA), etc.

It should be understood that the light source that emits light or performs photoelectric conversion involved in the description of the embodiments of the present application may be a laser or an ordinary light source, or may be visible light, infrared light, or ultraviolet light, which is not limited in the present application.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. A fishing reel electromagnetic braking device, applied to a fishing reel having an outlet guide ring and a winding reel, comprising a braking coil and a magnetic braking member rotating integrally with the winding reel, wherein the braking coil is fixedly disposed on a fishing reel body, and the braking coil brakes the winding reel through electromagnetic induction when a line is released, wherein the fishing reel electromagnetic braking device further comprises:
a guide ring speed measurement mechanism, which is a linear speed sensor disposed at a line outlet of the fishing reel and is configured to detect speed information of a fishing line passing through the outlet guide ring, wherein the fishing line is provided with signal marker sequences arranged at intervals, and the signal marker sequences match geometric parameters of the winding reel, such that interval lengths of the signal marker sequences increase or decrease in proportion to an increase or a decrease of a winding diameter of the fishing line on the winding reel, and a ratio of the interval lengths of the signal marker sequences to the corresponding winding diameter meets a preset value;
a rotation detection mechanism, which is disposed on the fishing reel body and comprises a rotation speed sensor configured to detect rotation speed information of the winding reel;
a controller, which is disposed on the fishing reel body and comprises a processor, a memory, and a current control unit, wherein the controller is electrically connected with the guide ring speed measurement mechanism and the rotation detection mechanism, the current control unit is electrically connected with the braking coil, and the memory stores the preset value;
when the line is released, the controller performs a closed-loop control by the following manner: the controller calculates a count of signal markers of the fishing line passing through a line outlet and a rotation angle of the winding reel within the same time period, then calculates a fishing line speed through the outlet guide ring and a tangential speed according to the count of signal markers, the rotation angle of the winding reel, and the preset value to calculate a correction signal for correcting a rotation speed of the winding reel, and controls an electromagnetic induction current in the braking coil through the current control unit according to the correction signal.

21. The fishing reel electromagnetic braking device according to claim 20, wherein the linear speed sensor is disposed on an inner wall or a side of the outlet guide ring of the fishing reel, and a detection direction of the linear speed sensor points to the fishing line passing through the line outlet, wherein the guide ring speed measurement mechanism detects speed information and send the speed information to the controller for processing, which is implemented in any of the following manners:
the guide ring speed measurement mechanism further comprises a projection light source and a photoelectric sensor, and the signal marker sequences are formed by color segments with different reflectivities arranged at intervals, wherein the projection light source illuminates the fishing line, and the photoelectric sensor converts a detected reflected light signal into an electrical pulse signal;
or, the guide ring speed measurement mechanism is a magneto-sensitive sensor, and the signal marker sequences are formed by magnetic markers arranged at intervals, wherein the magneto-sensitive sensor converts a detected magnetic signal into an electrical pulse signal.

22. The fishing reel electromagnetic braking device according to claim 20, wherein the controller controls the electromagnetic induction current in the braking coil in any of the following manners:
the current control unit is a switching element, and the correction signal controls connection and disconnection of the switching element by switching on and off;
or, the current control unit is a switching element, and the correction signal controls a duration proportion of connection and disconnection of the switching element by adjusting a PWM signal duty cycle;
or, the current control unit is a current intensity adjustment element, and the correction signal adjusts a current intensity in the current intensity adjustment element by changing an intensity.

23. The fishing reel electromagnetic braking device according to claim 21, wherein the controller controls the electromagnetic induction current in the braking coil in any of the following manners:
the current control unit is a switching element, and the correction signal controls connection and disconnection of the switching element by switching on and off;
or, the current control unit is a switching element, and the correction signal controls a duration proportion of connection and disconnection of the switching element by adjusting a PWM signal duty cycle;
or, the current control unit is a current intensity adjustment element, and the correction signal adjusts a current intensity in the current intensity adjustment element by changing an intensity.

24. The fishing reel electromagnetic braking device according to claim 20, wherein the closed-loop control is implemented in any one of the following manners:
the fishing line speed through the outlet guide ring is used as an input target control quantity, and the tangential speed is used as an output controlled quantity and a feedback quantity;
or, a set allowable speed difference threshold is used as an input target control quantity, and a difference between the tangential speed and the fishing line speed through the outlet guide ring is used as an output controlled quantity and a feedback quantity;
or, a set allowable floating line length threshold is used as an input target control quantity, and a floating line length is used as an output controlled quantity and a feedback quantity;
or, a set integral difference control value is used as an input target control quantity, and a speed integral difference is used as an output controlled quantity and a feedback quantity.

25. The fishing reel electromagnetic braking device according to claim 21, wherein the closed-loop control is implemented in any one of the following manners:
the fishing line speed through the outlet guide ring is used as an input target control quantity, and the tangential speed is used as an output controlled quantity and a feedback quantity;
or, a set allowable speed difference threshold is used as an input target control quantity, and a difference between the tangential speed and the fishing line speed through the outlet guide ring is used as an output controlled quantity and a feedback quantity;
or, a set allowable floating line length threshold is used as an input target control quantity, and a floating line length is used as an output controlled quantity and a feedback quantity;
or, a set integral difference control value is used as an input target control quantity, and a speed integral difference is used as an output controlled quantity and a feedback quantity.

26. The fishing reel electromagnetic braking device according to claim 20, wherein the rotation speed sensor is a photoelectric sensor, a Hall sensor, an aberration speed sensor, an electromagnetic sensor, or an inductive sensor.

27. The fishing reel electromagnetic braking device according to claim 21, wherein the rotation speed sensor is a photoelectric sensor, a Hall sensor, an aberration speed sensor, an electromagnetic sensor, or an inductive sensor.

28. A fishing line, wherein the fishing line is matched with the fishing reel electromagnetic braking device as described in claim 20.

29. A fishing line, wherein the fishing line is matched with the fishing reel electromagnetic braking device as described in claim 21.

30. A fishing reel electromagnetic braking device, wherein a fishing reel equipped with the fishing reel electromagnetic braking device comprises an outlet guide ring and a winding reel for reeling and releasing a fishing line in a rotation manner, the fishing reel electromagnetic braking device comprises a braking mechanism, and the braking mechanism comprises a braking coil and a magnetic braking member disposed opposite to each other, wherein one of the magnetic braking member and the braking coil rotates integrally with the winding reel to form a rotor, and the other of the magnetic braking member and the braking coil is disposed on a fishing reel body to form a stator, when a line is released, the magnetic braking member and the braking coil rotate relative to each other, and interact with each other to generate electromagnetic induction to brake the winding reel, wherein the fishing reel electromagnetic braking device further comprises:
a guide ring speed measurement mechanism, which is a linear speed sensor disposed on an inner wall of the outlet guide ring and is configured to detect speed information of the fishing line passing through the outlet guide ring;
a rotation detection mechanism, which is disposed on the fishing reel body and comprises a main rotation speed sensor and a rotation direction detection device, wherein the rotation detection mechanism is configured to detect the rotation information of the winding reel, and the rotation information comprises information about a rotation pulse and a rotation direction; and
a controller, which is disposed on the fishing reel body and comprises a processor, a memory, a current control unit, and an I/O interface, wherein the controller is electrically connected with the guide ring speed measurement mechanism and the rotation detection mechanism through the I/O interface, the current control unit is electrically connected with the braking coil, and the memory records and stores a conversion relationship parameter between a count of winding turns, a rotation speed, and a tangential speed of the winding reel;
when the line is released, the controller controls a braking force of the winding reel to realize a closed-loop control in the following manner:
calculating a fishing line speed through the outlet guide ring according to the speed information; calculating the rotation direction, the rotation speed, and the count of winding turns of the winding reel according to the rotation information, wherein the count of winding turns is stored in the memory; when the rotation direction of the winding reel is to release the line, calculating the tangential speed according to the count of winding turns, the rotation speed, and the conversion relationship parameter of the winding reel, calculating a correction signal for correcting the rotation speed of the winding reel according to the fishing line speed through the outlet guide ring simultaneous with the tangential speed, and controlling an electromagnetic induction current in the braking coil through the current control unit according to the correction signal.

31. The fishing reel electromagnetic braking device according to claim 30, wherein the guide ring speed measurement mechanism detects the speed information and sends the speed information to the controller for processing, which is implemented in any of the following manners:
the guide ring speed measurement mechanism further comprises a projection light source and a photoelectric sensor, and the fishing line used is spaced by color segments of different reflectivities with a first fixed marker length, wherein the projection light source illuminates the fishing line, and the photoelectric sensor converts a detected reflected light signal into an electrical pulse signal, and the fishing line speed through the outlet guide ring is calculated based on the electrical pulse signal and the first fixed marker length;
or the guide ring speed measurement mechanism further comprises a projection light source and an image sensor, wherein the projection light source illuminates the fishing line, the image sensor picks up information about local images of the moving fishing line at a fixed time interval, the controller performs a front-to-back comparison analysis on the local images, and the fishing line speed through the outlet guide ring is calculated based on a distance moved by the local images at the fixed time interval;
or the guide ring speed measurement mechanism is a magneto-sensitive sensor, and the fishing line used is spaced by magnetic markers with a second fixed marker length, wherein the magneto-sensitive sensor converts a detected magnetic signal into an electrical pulse signal, and the fishing line speed through the outlet guide ring is calculated based on the electrical pulse signal and the second fixed marker length.

32. The fishing reel electromagnetic braking device according to claim 30, wherein the controller controls the electromagnetic induction current in the braking coil in any of the following manners:
the current control unit is a switching element, and the correction signal controls connection and disconnection of the switching element by switching on and off;
or, the current control unit is a switching element, and the correction signal controls a duration proportion of connection and disconnection of the switching element by adjusting a PWM signal duty cycle;
or, the current control unit is a current intensity adjustment element, and the correction signal adjusts a current intensity in the current intensity adjustment element by changing an intensity.

33. The fishing reel electromagnetic braking device according to claim 30, wherein the closed-loop control is implemented in any one of the following manners:
the fishing line speed through the outlet guide ring is used as an input target control quantity, and the tangential speed is used as an output controlled quantity and a feedback quantity;
or, a set allowable speed difference threshold is used as an input target control quantity, and a difference between the tangential speed and the fishing line speed through the outlet guide ring is used as an output controlled quantity and a feedback quantity;
or, a set allowable floating line length threshold is used as an input target control quantity, and a floating line length is used as an output controlled quantity and a feedback quantity;
or, a set integral difference control value is used as an input target control quantity, and a speed integral difference is used as an output controlled quantity and a feedback quantity.

34. The fishing reel electromagnetic braking device according to claim 30, wherein the main rotation speed sensor is a photoelectric sensor, a Hall sensor, an aberration speed sensor, an electromagnetic sensor, or an inductive sensor, wherein the electromagnetic sensor or the inductive sensor can be implemented using at least one single coil of the braking coil serving as a speed measurement coil.

35. The fishing reel electromagnetic braking device according to claim 30, wherein linear speed sensor includes a grating sensor, a magnetic grating sensor, and an aberration speed sensor.

36. The fishing reel electromagnetic braking device according to claim 31, wherein the first and second fixed marker lengths are both less than 0.85 m.

37. The fishing reel electromagnetic braking device according to claim 32, wherein the switching element includes a field effect transistor (FET), a switching triode, a thyristor, or a combination thereof.

38. A speed measurement mechanism, wherein the speed measurement mechanism is a linear speed sensor disposed on an inner wall of an outlet guide ring and is configured to detect speed information of a fishing line passing through the outlet guide ring, wherein the speed measurement mechanism is further provided with a light escape notch disposed on the inner wall of the outlet guide ring, and a detection direction of the linear speed sensor exactly faces the light escape notch, which is implemented in any of the following manners:
the speed measurement mechanism further comprises a projection light source and a photoelectric sensor, and the fishing line used is spaced by color segments of different reflectivities with a first fixed marker length, wherein the projection light source illuminates the fishing line, the photoelectric sensor converts a detected reflected light signal into an electric pulse signal, and a fishing line speed through the outlet guide ring is measured based on the electric pulse signal and the first fixed marker length;
or, the speed measurement mechanism further comprises a projection light source and an image sensor, wherein the projection light source illuminates the fishing line, and the image sensor picks up information about local images of the moving fishing line at a fixed time interval, wherein a front-to-back comparison analysis is performed on the local images, and a fishing line speed through the outlet guide ring is calculated based on a distance moved by the local images at the fixed time interval.
